(19) United States
(12) Patent Application Publication
(10) Pub. No.: US 2020/0037765 A1
(43) Pub. Date: Feb. 6, 2020

(54) SEAT

(71) Applicant: TS TECH CO., LTD., Asaka-shi, Saitama (JP)

(72) Inventors: Kensuke MIZOI, Shioya-gun, Tochigi (JP); Hiroshi TAKANOHASHI, Shioya-gun, Tochigi (JP)

(21) Appl. No.: 16/488,084

(22) PCT Filed: Sep. 27, 2017
(86) PCT No.: PCT/JP2017/034833

§ 371 Date: Aug. 22, 2019

(30) Foreign Application Priority Data
Feb. 23, 2017 (JP) 2017-032686
Feb. 23, 2017 (JP) 2017-032689
Feb. 23, 2017 (JP) 2017-032690

(51) Int. Cl. A47C 7/30; B60N 2/68

(52) U.S. Cl. CPC A47C 7/30; B60N 2/72; B60N 2/68

(57) ABSTRACT

Provided is a seat which includes: a cushion frame including left and right side frames located separately from each other in a lateral direction, and front and rear cross members by which the left and right side frame are connected; left and right second supporting wires located separately from each other in a lateral direction and laid to connect the front and rear cross members; and left and right side supporting members made of plastic and formed integrally with the second supporting wires. The side supporting members have engagement portions which are engaged with the side frames.

### TECHNICAL FIELD

The present invention relates to a seat.

### BACKGROUND ART

A seat comprising a cushion frame, S springs laid across the inside of the cushion frame, and left and right inclining plates which, together with the S springs, support a pad is disclosed, for example, in Patent Document 1.

Also known in the art is a cushion pad formed of foam materials having different degrees of hardness. For example, Patent Document 2 discloses a seat cushion which includes a center portion (a seating surface section), and left and right side portions (frames) which bulge upward farther than the center portion, wherein left and right regions including at least part of the side portions, such as outer regions of the side portions, are formed of a hard foam material, and a region at their inside is formed of a soft foam material.

### CITATION LIST

### Patent Literature

Patent Document 1: JP 2016-117406 A
Patent Document 2: JP S63-172614 A

### SUMMARY OF INVENTION

The seat disclosed in Patent Document 1 requires assembly steps in which the S springs should be located in, laid on, and attached to the cushion frame, and moreover, the left and right inclining plates should be located at and secured by screws to the cushion frame; such many assembly steps would be deemed disadvantageously burdensome.

Furthermore, in the seat disclosed in Patent Document 1, the left and right inclining plates should be located at, and secured by the screws to the cushion frame independently of other members to be attached, which would disadvantageously increase the assembly steps required when the members are attached to the cushion frame.

On the other hand, it would be desirable to provide a seat which offers less fatigue felt even on long periods of sitting, which however is not taken into consideration in the conventional arts.

With these in view, it is an object of the present invention to provide a seat which may be assembled in reduced number of assembly steps.

It is another object of the present invention to provide a person with an improved ride comfort when seated on a seat.

It is yet another object of the present invention to facilitate attachment of members to a cushion frame.

It is yet another object of the present invention to reduce the number of steps for attaching members to a cushion frame.

It is yet another object of the present invention to lessen fatigue felt even on long periods of sitting.

It is yet another object of the present invention to reduce the number of steps required when manufacturing a seat.

It is yet another object of the present invention to reduce a weight of a seat.

It is yet another object to provide a thinner cushion pad.

It is yet another object to support a seated person stably while ensuring his/her improved ride comfort.

In order to achieve the aforementioned objects, a seat consistent with the present invention comprising: a cushion frame including left and right side frames disposed separately from each other in a lateral direction, and front and rear cross members by which the left and right side frames are connected; left and right linear members located separately from each other in the lateral direction and laid to connect the front and rear cross members; and left and right side supporting members made of plastic and formed integrally with the linear members, wherein the side supporting members each include an engagement portion engageable with a corresponding side frame.

With this configuration, the both of the linear members and the side supporting members can be attached to the cushion frame by laying the linear members to connect the front and rear cross members and engaging the engagement portion of each side supporting member with the corresponding side frame; accordingly, the steps of locating the side supporting members in their installation places independently of the linear members and securing the side supporting members by screws may be obviated. Consequently, the number of assembly steps can be reduced.

The seat described above may be configured such that each side supporting member has a first supporting surface located at a laterally inner side of the side frame, wherein the first supporting surface is so located as to extend obliquely in a laterally-outward-and-upward direction.

With this configuration, a recessed contour fitting the shape of a human body as viewed from the front or the rear may be formed by the linear members and the first supporting surfaces of the left and right side supporting members, so that a person when seated on the seat can be provided with an improved ride comfort.

The seat described above may be configured such that the side supporting members each include a plate-shaped supporting portion disposed at a laterally inner side of the side frame, wherein at least part of the supporting portion has a width in a front-rear direction increasing toward a laterally inner end.

With this configuration, the laterally outer portion of the supporting portion has a relatively small width in the front-rear direction, so that the supporting portion can be deflected moderately, while the laterally inner portion of the supporting portion has a relatively great width in the front-rear direction, so that a load can be supported by the greater-width portion. Accordingly, a person when seated on the seat can be provided with an improved ride comfort.

The seat described above may be configured such that the engagement portion is configured to hook on the side frame from above, to thereby engage with the side frame.

With this feature, the side supporting members can be attached to the cushion frame with ease.

The seat described above may be configured such that the left and right side supporting members are connected by and integrally formed with a connecting part extending in the lateral direction.

With this feature, the left and right side supporting members and the left and light linear members may be manipulated as an integral part, so that the number of assembly steps can be further reduced.

The seat described above may comprise a rear supporting member made of plastic, the rear supporting member being formed integrally with rear end portions of the left and right linear members and connecting the left and right linear members.

With this feature, in which the left and right linear members are connected by the rear supporting member, the left and right linear members and the left and right side supporting members can be manipulated as an integral part, so that the number of assembly steps can be further reduced.

The seat described above may be configured such that the rear supporting member has a second supporting surface located frontward of the rear cross member, wherein the second supporting surface is so located as to extend obliquely in a rearward-and-upward direction.

With this feature, a portion contoured to fit the shape of a human body as viewed from a left or right side may be formed by the linear members and the second supporting surface of the rear supporting member, so that a person when seated on the seat can be provided with an improved ride comfort.

The seat described above may be configured such that the left and right side supporting members are connected to and formed integrally with the rear supporting member.

With this feature, the left and right side supporting members, the rear supporting member and the left and right linear members may be configured as an easy-to-manipulate integral part, so that these can be attached to the cushion frame with ease.

The seat described above may comprise left and right cover members made of plastic, with which at least laterally inner sides of rear end portions of the side frames are covered, wherein the side supporting members are connected to and formed integrally with the cover member.

With this feature, the cover members, the side supporting members and the linear members can be manipulated as an integral part, so that the number of assembly steps can be further reduced.

In another aspect, a seat comprises a cushion frame including left and right side frames disposed separately from each other in a lateral direction; a pad supporting member disposed between the left and right side frames to support a cushion pad; left and right cover members made of plastic, with which at least laterally inner sides of rear end portions of the side frames are covered; and left and right side supporting members located respectively on the left and right sides of the pad supporting member and configured to support the cushion pad in coordination with the pad supporting member, wherein the side supporting members are provided in the cover members.

With this configuration, the both of the cover members and the side supporting members can be attached to the cushion frame by attaching the cover members to the side frames; accordingly, the steps of locating the side supporting members in their installation places independently of the cover members and securing the side supporting members by screws may be obviated. Consequently, the number of assembly steps required when members are attached to the cushion frame can be reduced.

The seat described above may be configured such that the left and right side supporting members are located, respectively, on left and right sides of a hip point of a seated person, wherein each of the side supporting members is located within a range including the hip point in a front-rear direction.

With this arrangement, when a person is seated on the seat, side portions of the buttocks and femoral regions of the seated person can be supported by the left and right supporting members; thus, the pressure placed on the ischial bones and their vicinities are lowered relatively, so that the seated person can be supported on the entire region including the ischial bones and their vicinities, the buttocks, and the femoral regions with properly balanced pressure distribution. Accordingly, the blood circulation around the ischial bones of the seated person is rendered unlikely to become poor, and the fatigue that would be felt can be reduced even on long periods of sitting.

The seat described above may be configured such that each side supporting member has a supporting surface located at a laterally inner side of the side frame, wherein the supporting surface is so located as to extend obliquely in a laterally-outward-and-upward direction.

With this configuration, a recessed contour fitting the shape of a human body as viewed from the front or the rear may be formed by the pad supporting member and the supporting surfaces of the left and right side supporting members, so that a person when seated on the seat can be provided with an improved ride comfort.

The seat described above may be configured such that the side supporting members are formed integrally with the cover members.

With this configuration, the number of steps required when manufacturing the seat can be reduced.

The seat described above may be configured such that the cover members each include an inner cover portion with which laterally inner sides of the rear end portion of the corresponding side frame is covered, wherein the side supporting members each include a supporting portion disposed at a laterally inner side of the corresponding side frame and provided adjacent to the inner cover portion, and wherein a slit cut from an edge on a laterally inner side toward a laterally outer side is provided between the inner cover portion and the supporting portion.

With this configuration, in which the cover member and the side supporting member are configured as one integral member, whereas the inner cover portion and the supporting portion are divided by the slit, the supporting portion is rendered likely to deflect, so that a person when seated on the seat can be provided with an improved ride comfort.

The seat described above may be configured such that the supporting portion has a width of 10 centimeters or more in a front-rear direction.

With this feature, a load can be supported by the supporting portion having a great width, so that a person when seated on the seat can be provided with an improved ride comfort.

The seat described above may be configured such that each side supporting member includes a plate-shaped supporting portion located at a laterally inner side of the side frame, wherein at least part of the supporting portion has a width in a front-rear direction increasing toward a laterally inner end.

With this configuration, the laterally outer portion of the supporting portion has a relatively small width in the front-rear direction, so that the supporting portion can be deflected moderately, while the laterally inner portion of the supporting portion has a relatively great width in the front-rear direction, so that a load can be supported by the greater-width portion. Accordingly, a person when seated on the seat can be provided with an improved ride comfort.

The seat described above may be configured such that the cushion frame comprises front and rear cross members by which the left and right side frames are connected, wherein the pad supporting member incorporates left and right linear members located separately from each other in the lateral direction and laid to connect the front and rear cross members, and wherein the side supporting members have laterally inner ends connected to the linear members.

With this configuration, the side supporting members serve to restrain the linear members from sinking down excessively, so that a person when seated on the seat can be provided with an improved ride comfort.

The seat described above may be configured such that the side supporting members each include a supporting portion disposed at a laterally inner side of the side frame, wherein the supporting portion has a through hole.

With this configuration, the side supporting members can be made lighter, and the seat including the side supporting members can be made lighter accordingly. Moreover, this makes it possible to dispose any other member through the through hole, so that the limited space inside the seat can be utilized effectively.

In still another aspect, the seat is configured as a seat including a cushion pad, wherein the cushion pad includes a first pad layer and left and right second pad layers that are harder than the first pad layer and disposed under the first pad layer on left and right sides of a hip point of a seated person, respectively, wherein each second pad layer has an interface with the first pad layer, which interface is, in a cross section intersecting the hip point and extending perpendicular to a front-rear direction, located to extend obliquely downward with respect to a direction toward a laterally inner side of the cushion pad and so shaped as to be recessed downward.

With this configuration, in which the interface between the second pad layer and the first pad layer is located to extend obliquely downward with respect to a direction toward the laterally inner side of the cushion pad and so shaped as to be recessed downward, the interface of the second pad layer can be contoured to fit the shape of a human body. Moreover, when a person is seated on the seat, side portions of the buttocks and femoral regions of the seated person can be supported by the second pad layers; thus, the pressure placed on the ischial bones and their vicinities are lowered relatively, so that the seated person can be supported on the entire region including the ischial bones and their vicinities, the buttocks, and the femoral regions with properly balanced pressure distribution. Accordingly, the blood circulation around the ischial bones of the seated person is rendered unlikely to become poor, and the fatigue that would be felt can be reduced even on long periods of sitting.

The seat described above may be configured such that the cushion pad has, on left and right sides of the hip point, respectively, left and right grooves in which an outer covering is tucked, wherein the second pad layers are located astride the corresponding grooves in the lateral direction.

With this configuration, in comparison with an alternative configuration in which the second pad layers are located only on the laterally inner sides of the grooves, the second pad layers can be configured to have greater widths; accordingly, the interfaces of the second pad layers can be provided to fit laterally wide areas of a human body, particularly, of the side portions of the buttocks and the femoral regions thereof. Therefore, when a person is seated on the seat, the side portions of the buttocks and femoral regions of the seated person can be supported firmly by the second pad layers; thus, the fatigue that would be felt can be reduced even on long periods of sitting. Alternatively, if the second pad layers are located only on the laterally outer sides of the grooves, the second pad layers would be located in positions separate from the seated person, and thus, would not be able to sufficiently achieve the function of the second pad layers; on the contrary, if the second pad layers are located astride the grooves in the lateral direction, the function of the second pad layers can be achieved sufficiently, so that the fatigue that would be felt can be reduced even on long periods of sitting.

In the seat described above, the second pad layers may be configured to include portions located laterally inward of the grooves and each having a thickness decreasing in a laterally inward direction.

With this configuration, the cushion pad can be configured to be thinner in comparison with an alternative embodiment in which each second pad layer has a constant thickness.

In the seat described above, the first pad layer may be configured to include portions located laterally inward of the grooves and each having a thickness decreasing in a laterally outward direction.

With this configuration, the cushion pad can be configured to be thinner in comparison with an alternative configuration in which the first pad layer has a constant thickness.

In the seat described above, the second pad layers may include extension portions located rearward of the hip point and extending laterally inward.

With this configuration, rear portions of the buttocks of a seated person can be supported on the softer first pad layer by the hard second pad layers, so that the seated person can be supported stably while ensuring his/her improved ride comfort.

The seat described above may be configured such that the left and right second pad layers are connected by a laterally extending connecting portion located rearward of the hip point.

With this configuration, the entire rear portions of the buttocks of a seated person can be supported on the softer first pad layer by the hard second pad layers, so that the seated person can be supported stably while ensuring his/her improved ride comfort.

The seat described above may be configured such that the connecting portion is located under the first pad layer and an interface between the connecting portion and the first pad layer extends obliquely in a downward-and-frontward direction.

With this configuration, the interface between the connecting portion and the first pad layer may be contoured to fit the shape of the buttocks and lumber regions of a human body; accordingly, a person seated on the seat may not feel any sharp change in hardness thereon, and thus can be provided with an improved ride comfort.

The seat described above may be configured such that the second pad layers are not disposed in a range of a first distance from the hip point laterally outward, a range of a second distance from the hip point rearward, or a range of a third distance from the hip point frontward.

With this arrangement, as no second pad layer is disposed near the hip point, the pressure around the ischial bones can be lowered, thus eliminating the possibility of lowering the degree of alleviation of a feeling of fatigue which would result from the pressure placed on the ischial bones and their vicinities due to the presence of the hard second pad layer near the hip point. Accordingly, the blood circulation around the ischial bones of the seated person is rendered unlikely to become poor, and the fatigue that would be felt can be reduced even on long periods of sitting.

The seat described above may be configured such that at least part of the left and right second pad layers located frontward of the hip point has a width in a lateral direction decreasing toward a front end.

With this configuration, the hard second pad layer may be located gradually away from the femoral regions of a seated person with increasing distance toward frontward; accordingly, a person seated on the seat may not feel any sharp change in hardness thereon, and thus can be provided with an improved ride comfort.

The seat described above may be configured to comprise a plurality of supporting members which extends in a front-rear direction and supports the cushion pad from below, wherein the plurality of supporting members include a first supporting member disposed at a laterally central position, and left and right second supporting members disposed at left and right sides of the first supporting member, and wherein at least in a position corresponding to the hip point in the front-rear direction, the second pad layers are located over the second supporting members and not located over the first supporting member.

With this configuration, the second pad layers at the left and right sides of the hip point can be supported from below by the left and right second supporting members; accordingly, when a person is seated on the seat, the second pad layers can be restrained from sinking down. Consequently, the functionality of the second pad layers can be achieved sufficiently, so that the fatigue that would be felt can be reduced even on long periods of sitting. Moreover, since the first pad layer on and around the hip point can be supported from below by the first supporting member, the soft first pad layer can be restrained from sinking down excessively when a person is seated on the seat, so that an improved ride comfort can be achieved.

### BRIEF DESCRIPTION OF DRAWINGS

FIG. 1 is a perspective view of a car seat as a seat according to an embodiment.

FIG. 2 is a perspective view of a cushion frame incorporated in a seat cushion of a first embodiment.

FIG. 3 is a section view of a seat cushion as viewed with the line of sight aligned in the front-rear direction.

FIG. 4 is a view of a cushion pad as viewed from above.

FIG. 5 is a view of a cushion frame and a cover member as viewed from the rear.

FIG. 6 is a section view of a seat cushion on which an occupant is seated, as viewed with the line of sight aligned in the front-rear direction.

FIG. 7 is a perspective view of a cushion frame to be incorporated in a seat cushion of a second embodiment.

FIG. 8 is a section view of a seat cushion.

FIG. 9 is a section view of a seat cushion on which an occupant is seated.

FIG. 10 is a perspective view of a seat frame to be incorporated in a car seat of a third embodiment.

FIG. 11 is a view of a cushion pad according to the third embodiment as viewed from above.

FIG. 12 is a section view of a seat cushion corresponding to the IV-IV section of FIG. 11.

FIG. 13 is a section view of a seat cushion corresponding to the V-V section of FIG. 11.

FIG. 14 is a section view of a seat cushion on which an occupant is seated.

FIG. 15 is a perspective view of a cushion frame according to a first variation.

FIG. 16 is a section view of a seat cushion according to the first variation as viewed with the line of sight aligned in the lateral direction.

FIG. 17 is a perspective view of a cushion frame according to a second variation.

FIG. 18 is a perspective view of a cushion frame according to a third variation.

FIG. 19 is a perspective view of a cushion frame including side supporting members according to a fourth variation.

FIG. 20 includes section views (a) and (b) of a seat cushion including side supporting members according to a fifth variation.

FIG. 21 is a perspective view of a cushion frame including side supporting members according to a sixth variation.

FIG. 22 is a perspective view of a cushion pad according to a seventh variation as viewed from above.

FIG. 23 is a perspective view of a cushion pad according to an eighth variation as viewed from above.

FIG. 24 is a perspective view of a cushion pad according to a ninth variation as viewed from above.

### DESCRIPTION OF EMBODIMENTS

Hereinafter, a description will be given of embodiments of the invention with reference made to accompanying drawings. In this description, the front/rear (frontward/rearward), left/right (leftward/rightward; lateral), and upper/lower (upward/downward; vertical) are represented with reference to the front/rear, left/right, and upper/lower directions as viewed from a person seated on a seat (seated person).

### First Embodiment

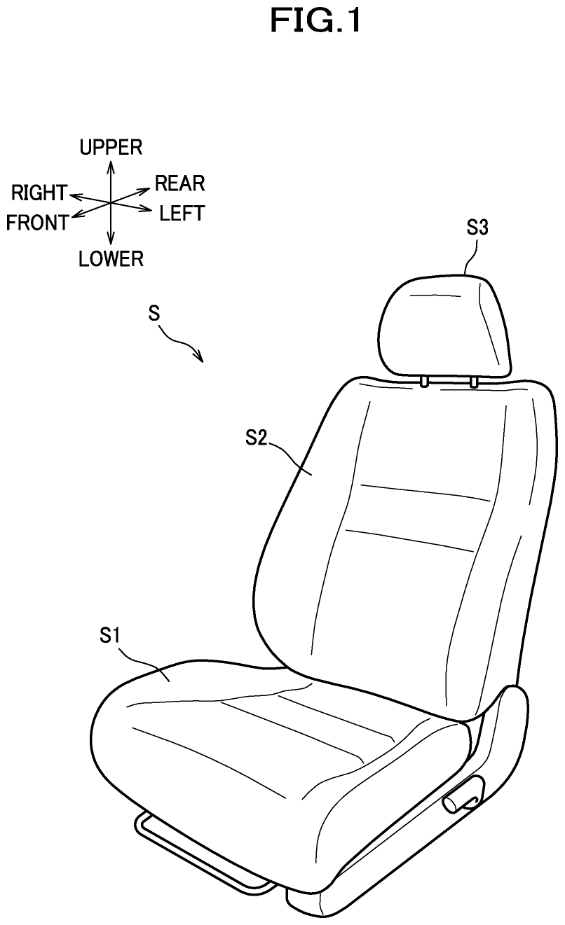

As shown in FIG. 1, a seat of the present embodiment is configured as a car seat S installed in an automobile, and includes a seat cushion S1, a seat back S2, and a headrest S3.

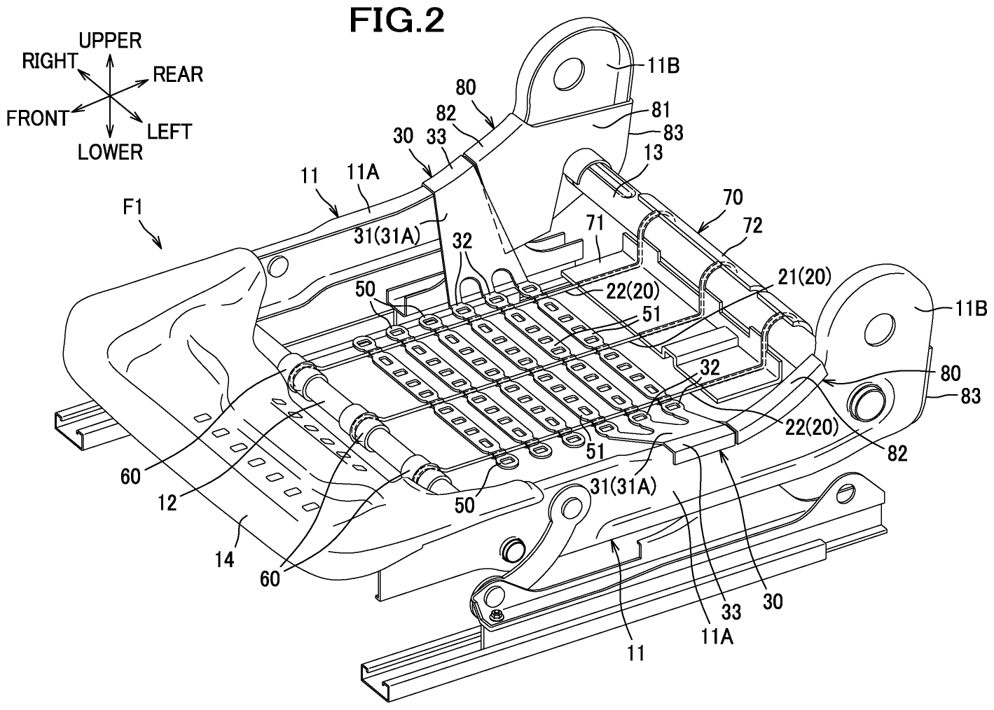

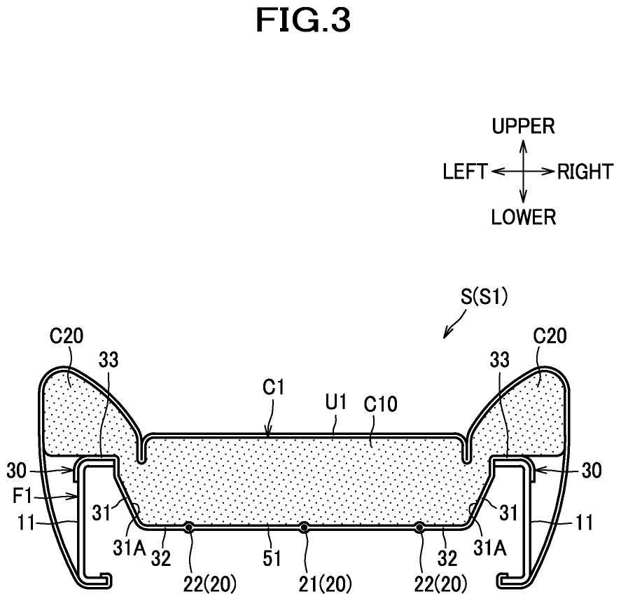

Inside the seat cushion S1, a cushion frame F1 as shown in FIG. 2 is incorporated. The cushion frame F1 is a member constituting a frame of the seat cushion S1. As shown in FIG. 3, the seat cushion S1 is constructed of the cushion frame F1 upholstered with a cushion pad C1 made of urethane foam or the like and an outer covering U1 made of fabrics, leather or the like.

As shown in FIG. 2, the cushion frame F1 includes left and right side frames 11, a front frame 12 and a rear frame 13 as front and rear cross members, and a pan frame 14.

The left and right side frames 11 are frames formed of sheet metal, and disposed separately from each other in a lateral direction. Each side frame 11 includes a side frame body 11A extending approximately in a front-rear direction, and a back attachment portion 11B extending from a rear end portion of the side frame body 11A approximately upward, and forms a cross-sectional shape with a peripheral edge portion of the side frame 11 extending laterally inward. A back frame (not shown) constituting a frame of the seat back S2 may be rotatably attached to the back attachment portion 11B via a reclining mechanism. The seat back S2 is, similar to the seat cushion S1, constructed of a back frame upholstered with a padding made of urethane foam or the like and an outer covering.

The front frame 12 and the rear frame 13 are frames formed of a pipe material made of metal, and disposed separately from each other in the front-rear direction. The front frame 12 connects front portions of the left and right side frames 11 (side frame bodies 11A), while the rear frame 13 connects rear portions of the left and right side frames 11 (side frame bodies 11A).

The pan frame 14 is a frame formed of sheet metal, and disposed to connect front end portions of the left and right side frames 11.

Between the left and right side frames 11, three supporting wires 20 supporting the cushion pad C1 (see FIG. 3) from below are disposed. Each supporting wire 20 is disposed to extend in the front-rear direction to connect the front frame 12 and the rear frame 13. The supporting wire 20 is formed of a wire rod made of metal. A front end portion of the supporting wire 20 is angled to extend obliquely in a frontward-and-upward direction, and curved approximately in the form of a segment of a circle along an outer peripheral surface of the front frame 12. A rear end portion of the supporting wire 20 is angled to extend upward, and curved approximately in the form of a segment of a circle along an outer peripheral surface of the rear frame 13.

The supporting wire 20 includes one first supporting wire 21 and two second supporting wires 22 as an example of left and right linear members. The first supporting wire 21 is disposed at a laterally central position inside the cushion frame F1. The left and right second supporting wires 22 are disposed one on the left side, and the other on the right side, of the first supporting wire 21 inside the cushion frame F1. In other words, the left and right second supporting wires 22 are located separately from each other in the lateral direction, and the first supporting wire 21 is located therebetween.

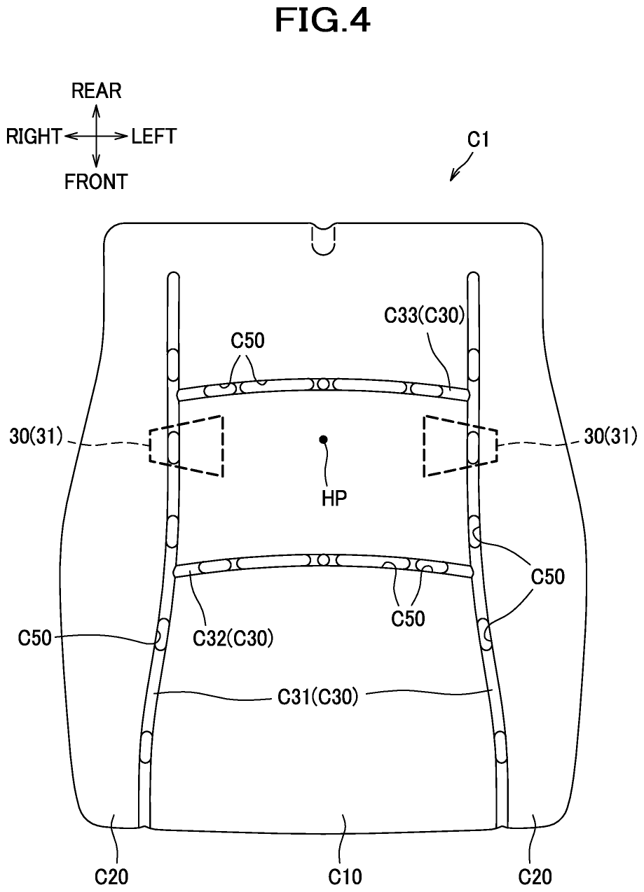

Side supporting members 30 are located on left and right sides of the supporting wires 20. The left and right side supporting members 30 are members configured to support the cushion pad C1 (see FIG. 3) in coordination with the supporting wires 20, and made of plastic. As shown in FIG. 4, the left and right side supporting members 30 are located one on the left side, and the other on the right side, of a hip point HP of a seated person. Each side supporting member 30 is located within a range including the hip point HP in the front-rear direction. In other words, the side supporting members 30 are located on the left and right sides of the hip point HP, across the hip point HP when viewed from above or below. In this description, the hip point HP is a position of a hip point of a 3D manikin seated on a seat as provided in SAE J-826 standard. As shown in FIG. 2, each side supporting member 30 includes a side supporting portion 31 as an example of a supporting portion, joint portions 32, and an engagement portion 33.

The side supporting portion 31 is a plate-shaped portion located at a laterally inner side of the side frame 11 and angled to extend obliquely in a laterally-outward-and-upward direction. Each side supporting portion 31 has a generally trapezoidal shape of which a width in the front-rear direction increases toward a laterally inner end (see also FIG. 4). The side supporting portion 31 may preferably have a width of 10 centimeters or more in the front-rear direction. To be more specific, the width of an uppermost end of the side supporting portion 31, which is the smallest width thereof in the front-rear direction, may preferably be 10 centimeters or more.

Each side supporting portion 31 has a first supporting surface 31A that is an upper surface thereof. In the present embodiment, the plate-shaped side supporting portion 31 is so located as to extend obliquely in a laterally-outward-and-upward direction, and thus has its first supporting surface 31A inclined to assume a slope that extends obliquely in a laterally-outward-and-upward direction. Each side supporting portion 31 has a trifurcated lower end portion.

The joint portions 32 are provided to extend from the lower end of the side supporting portion 31 (specifically, each of distal ends of the trifurcated portion) laterally inward. Laterally inner end portions of the joint portions 32 are joined to the second supporting wire 22. To be more specific, the joint portions 32 are provided, as shown in FIG. 3, such that with their laterally inner end portions, parts of the second supporting wires 22 are covered around their entire circumferences as if the parts of the second supporting wires 22 are enveloped. In other words, the second supporting wires 22 are disposed through the laterally inner end portions of the joint portions 32. The side supporting members 30 made of plastic, which have their joint portions 32 joined to the second supporting wires 22 in this way, are thus formed integrally with the second supporting wires 22 made of metal.

The engagement portion 33 is a portion engageable with the side frame 11. Specifically, the engagement portion 33 extends from an upper end of the side supporting portion 31 upward, then extends along an upper surface of the side frame 11 laterally outward, and further extends downward, to have an approximately U-shaped cross section (a shape of a hook). The engagement portion 33 is hooked on the upper end portion of the side frame 11 from above, and thereby engaged with the side frame 11.

In the present embodiment, the left and right side supporting members 30 are connected by a connecting part 51. The connecting part 51 is a generally plate-shaped member made of plastic, and is disposed to extend laterally between the joint portions 32 of the left and right side supporting members 30. The connecting part 51 is formed integrally with the joint portions 32 of the side supporting members 30 to connect the left and right side supporting members 30.

As shown in FIG. 2, the connecting part 51 is provided in three positions, corresponding to three sets of joint portions 32 arranged in the front-rear direction; thus, the total three connecting parts 51 are provided one for each set of joint portions 32. A laterally central portion of each connecting part 51 is connected with the first supporting wire 21 and formed integrally with the first supporting wire 21. To be more specific, each connecting part 51 is provided such that with its laterally central portion, part of the first supporting wire 21 is covered around its entire circumference as if the part of the first supporting wire 21 is enveloped (see also FIG. 3). In other words, the first supporting wire 21 is disposed through the laterally central portion of each connecting part 51.

Further, in the present embodiment, the three supporting wires 20, particularly, the front portions thereof located frontward of the connecting parts 51, are connected by a plurality of wire connecting members 50 arranged side by side in the front-rear direction. The wire connecting members 50 are generally plate-shaped members made of plastic. Each wire connecting member 50 is provided such that with its laterally central portion, part of the first supporting wire 21 is covered around its entire circumference as if the part of the first supporting wire 21 is enveloped. Also, each wire connecting member 50 is provided such that with its laterally outer end portions, parts of the second supporting wires 22 are covered around their entire circumferences as if the parts of the second supporting wires 22 are enveloped. In this way, the first supporting wire 21 is disposed through the laterally central portion of each wire connecting member 50, and the second supporting wires 22 are disposed through the laterally outer end portions of each wire connecting member 50.

The joint portions 32 of the side supporting members 30, the connecting parts 51, and the wire connecting members 50 are formed with generally rectangular through holes (indication with reference characters omitted therefor) piercing through upper and lower sides. The car seat S of the present embodiment is configured such that a clip for use in holding a wire harness or the like may be engaged with any of the through holes of the joint portions 32, the connecting parts 51, and the wire connecting members 50, to thereby allow the wire harness or the like to be attached thereto. In other words, the joint portions 32, the connecting parts 51, and the wire connecting members 50 may serve as a mount to which a wire harness or the like is attached.

Sheathing members 60 are disposed respectively on front portions of the three supporting wires 20. The sheathing members 60 are made of plastic and provided such that the front end portion of each supporting wire 20 curved approximately in the form of a segment of a circle is covered and enveloped therewith, and are formed integrally with the respective supporting wires 20. Each sheathing member 60 has a tubular shape with a slit extending along the length in the lateral direction formed therein as if to generally assume the shape of a letter C in cross section. The front end portion of each supporting wire 20 is covered with the sheathing member 60 and hooked on the front frame 12.

A rear supporting member 70 is disposed rearward of the three supporting wires 20. The rear supporting member 70 is configured as a member supporting the cushion pad C1 in coordination with the supporting wires 20 and the side supporting members 30, and is made of plastic. The rear supporting member 70 is provided such that the rear end portions of the supporting wires 20 including the left and right second supporting wires 22 are covered and enveloped therewith, and is formed integrally with the supporting wires 20. The rear supporting member 70 includes a rear supporting portion 71 and a hook portion 72.

The rear supporting portion 71 is a plate-shaped member located frontward of the rear frame 13 that is the rear cross member, and generally assumes the shape of a letter L as viewed form the left or right side.

The hook portion 72 is a portion configured to cover the rear end portions of the supporting wires 20, and generally assumes the shape of a letter U as viewed from the left or right side.

The rear supporting portion 71 and a rear end portion of the hook portion 72 extend in the lateral direction and connect rear end portions of the three supporting wires 20 including the left and right second supporting wires 22.

The rear end portion of each supporting wire 20 is covered with the hook portion 72 of the rear supporting member 70 and hooked on the rear frame 13. In the car seat S of the present embodiment, the front end portions of the supporting wires 20 made of metal are covered with the sheathing members 60 made of plastic and are hooked on the front frame 12 made of metal, and the rear end portions of the supporting wires 20 made of metal are covered with the hook portion 72 made of plastic and are hooked on the rear frame 13 made of plastic, so that noises as would be produced by metal-to-metal contact can be prevented.

The supporting wires 20 made of metal, and the side supporting members 30, the connecting parts 51, the wire connecting members 50, the sheathing member 60, and the rear supporting member 70 made of plastic are integrally formed, for example, by insert molding.

The rear end portions of the respective side frames 11 are covered with corresponding cover members 80 so as to prevent a person from getting in touch with the side frames 11 made of metal. The left and the right cover members 80 are made of plastic, and each include an inner cover portion 81, an upper cover portion 82, and a rear cover portion 83.

The inner cover portion 81 is a portion with which a laterally inner side of the rear end portion of the side frame 11 is covered. The inner cover portion 81 is disposed in a position below the back attachment portion 11B, to cover an area extending from a position at a rear side of the side supporting member 30 to a rear edge of the side frame body 11A.

The upper cover portion 82 is a portion with which a portion of the rear end portion of the side frame 11 frontward of the back attachment portion 11B is covered from above, and is so provided as to extend from a front-side portion of an upper end of the inner cover portion 81 laterally outward. In the present embodiment, the upper cover portion 82 has its laterally outer end portion extending along a laterally outer surface of the side frame 11 downward, to generally assume the shape of a letter L in cross section, thus forming a shape that serves as a hook in combination with the inner cover portion 81. The cover member 80 has its hook-shaped structure (formed by the inner cover portion 81 and the upper cover portion 82) hooked on an upper end portion of the side frame 11 from above, and is thereby engaged with the side frame 11.

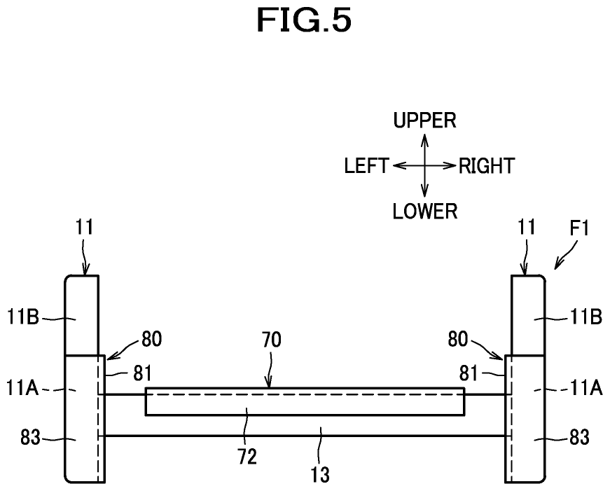

The rear cover portion 83 is, as show in FIG. 5, a portion with which the rear end of the side frame 11 is covered from the rear side, and is so provided as to extend from the rear end of the inner cover portion 81 laterally outward.

As shown in FIG. 4, the cushion pad C1 includes a center portion C10 and left and right side portions C20 so provided at the left and right sides of the center portion C10 as to bulge upward farther than the center portion C10. The cushion pad C1 has a tuck-in groove C30 for the outer covering U1 (see FIG. 3) to be tucked therein.

The tuck-in groove C30 includes left and right first grooves C31 that extend in the front-rear direction, and a second groove C32 and a third groove C33 that extend in the lateral direction.

The left and right first grooves C31 are formed at the left and right sides of the hip point HP to extend along borders between the center portion C10 and the respective side portions C20.

The second groove C32 is formed at the front side of the hip point HP to connect approximately central portions in the front-rear direction of the left and right first grooves C31.

The third groove C33 is formed at the rear side of the hip point HP to connect rear portions of the left and right first grooves C31.

In the cushion pad C1, a tuck-in wire (not shown) for use in tucking the outer covering U1 in the tuck-in groove C30 is embedded by insert molding. The tuck-in wire is located along the tuck-in groove C30 and partially exposed at a plurality of holes C50 formed at the bottom of the tuck-in groove C30. The outer covering U1 is anchored to the cushion pad C1 with hooks (not shown) provided on the outer covering U1 being engaged with exposed portions of the tuck-in wire through the holes C50.

The side supporting portions 31 of the side supporting members 30 are each located across the corresponding first groove C31 under the first groove C31 in the lateral direction. More specifically, the side supporting portion 31 and the corresponding first groove C31 are so located as to cross each other. The side supporting portions 31 are located in positions between the second groove C32 and the third groove C33 in the front-rear direction.

Next, a description will be given of operations and advantageous effects of the car seat S configured as described above.

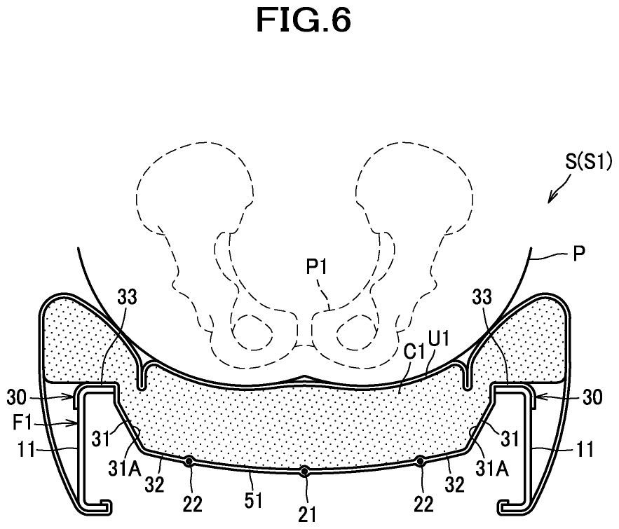

When a person (seated person P) is seated on the car seat S, the side portions of the buttocks and femoral regions of the seated person P can be held and supported from the laterally outer sides by the side supporting portions 31 of the left and right supporting members 30 located across the hip point HP at the left and right sides of the hip point HP, as shown in FIG. 6. With this configuration, the side portions of the buttocks and femoral regions of the seated person P can be supported more firmly in comparison with an alternative configuration in which no side supporting portion 31 is provided. As a result, the pressure placed around the ischial bones P1 (to be more precise, the lowermost position of the protruding ischial bones P1, the same applies in the following description) is lowered relatively, so that the seated person P can be supported on the entire region including the ischial bones P1 and their vicinities, the buttocks, and the femoral regions with properly balanced pressure distribution. Accordingly, the blood circulation around the ischial bones P1 of the seated person P is rendered unlikely to become poor, and the fatigue that would be felt by the seated person P can be reduced even on long periods of sitting.

Since the left and right side supporting members 30 formed integrally with the second supporting wires 22 include the engagement portions 33 engageable with the side frames 11, the both of the supporting wire 20 and the side supporting member 30 can be attached to the cushion frame F1 by laying the second supporting wires 22 and other parts on the front frame 12 and the rear frame 13 and engaging the engagement portions 33 with the side frames 11. With this configuration, the steps of locating the side supporting members in their installation places independently of the supporting wires and securing the side supporting members by screws may be obviated; consequently, the number of assembly steps can be reduced.

Since the first supporting surface 31A of the side supporting member 30 is so located as to form an inclined surface that extends obliquely in a laterally-outward-and-upward direction, the supporting wires 20 and the left and right first supporting surfaces 31A together can be contoured to form a recessed shape fitting the shape of a human body (seated person P) as viewed from the front or rear side. Accordingly, the seated person P when seated on the car seat S can be supported stably, so that an improved ride comfort can be achieved.

Moreover, since the supporting portion 31 has a width in the front-rear direction increasing toward a laterally inner end, the laterally outer portion of the side support portion 31 has a relatively small width in the front-rear direction, so that the supporting portion 31 can be deflected moderately in the vertical direction, providing an adequate cushiony property. Moreover, since the laterally inner portion of the side supporting portion 31 has a relatively great width in the front-rear direction, a load can be supported by the greater-width portion; accordingly, a seated person P when seated on the car seat S can be provided with an improved ride comfort. It is to be understood that the width in the front-rear direction of the upper end (i.e., the smallest width in the front-rear direction) of the side supporting portion 31 may be 10 centimeters or more, so that the strength of a portion of the side supporting portion 31 near the upper end on which a great load is imposed when deflected can be increased.

Since the engagement portion 33 is configured to hook on the side frame 11 from above, to thereby engage with the side frame 11, the side supporting members 30 can be attached to the cushion frame F1 with ease.

Since the left and right side supporting members 30 are connected by and integrally formed with the connecting part 51, the left and right side supporting members 30 and the supporting wires 20 can be manipulated as an integral part. With this configuration, the number of assembly steps for the car seat S can be further reduced in comparison with an alternative configuration in which the left and right supporting members are located and attached respectively.

Furthermore, the rear end portions of the supporting wires 20 are connected by the rear supporting member 70; with this configuration as well, the supporting wires 20 and the left and right side supporting members 30 can be manipulated as an integral part. Accordingly, the number of assembly steps for the car seat S can be further reduced, in comparison with an alternative configuration in which the rear end portions of a plurality of supporting wires are hooked on the rear frame 13 one by one.

Since the left and right side supporting members 30 are formed integrally with the connecting part 51, the rear supporting member 70 and other parts, the supporting wires 20, the left and right side supporting members 30 and the rear supporting member 70 are configured as an easy-to-manipulate integral part. Therefore, these components can be attached to the cushion frame F1 with ease.

### Second Embodiment

Next, a description will be given of a second embodiment. In the following, the same components as those described above will be designated with the same reference characters, and a description thereof will be omitted where appropriate, and features distinct from those described above will be explained in detail.

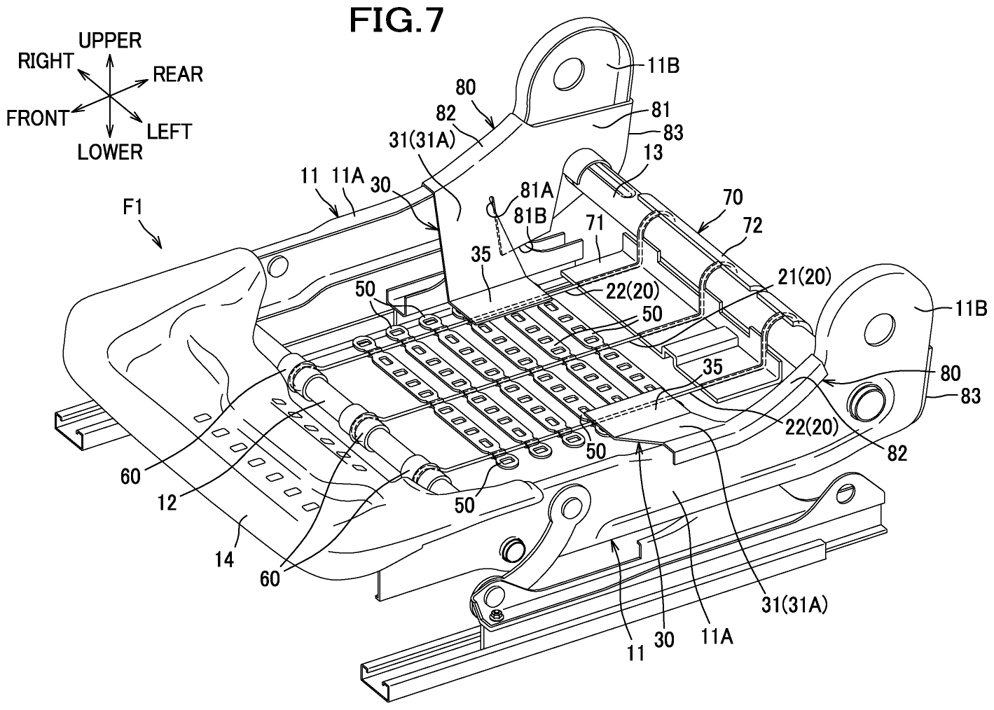

As shown in FIG. 7, in this embodiment, three supporting wires 20, as an example of a pad supporting member, are connected by a plurality of wire connecting members 50 arranged side by side in the front-rear direction. The wire connecting members 50 are generally plate-shaped members made of plastic. Each wire connecting member 50 is provided such that with its laterally central portion, part of the first supporting wire 21 is covered around its entire circumference as if the part of the first supporting wire 21 is enveloped. Also, each wire connecting member 50 is provided such that with its laterally outer end portions, parts of the second supporting wires 22 are covered around their entire circumferences as if the parts of the second supporting wires 22 are enveloped. In this way, the first supporting wire 21 is disposed through the laterally central portion of each wire connecting member 50, and the second supporting wires 22 are disposed through the laterally outer end portions of each wire connecting member 50.

The wire connecting members 50 are formed with generally rectangular through holes (indication with reference characters omitted therefor) piercing through upper and lower sides. The car seat S of the present embodiment is configured such that a clip for use in holding a wire harness or the like may be engaged with any of the through holes of the wire connecting members 50, to thereby allow the wire harness or the like to be attached thereto. In other words, the wire connecting members 50 may serve as a mount to which a wire harness or the like is attached.

A rear supporting member 70 is disposed rearward of the three supporting wires 20. The rear supporting member 70 is configured as a member supporting the cushion pad C1 in coordination with the supporting wires 20 and other parts, and is made of plastic.

The supporting wires 20 made of metal, as well as the wire connecting members 50, the sheath members 60, and the rear supporting member 70 made of plastic are formed, for example, by insert molding.

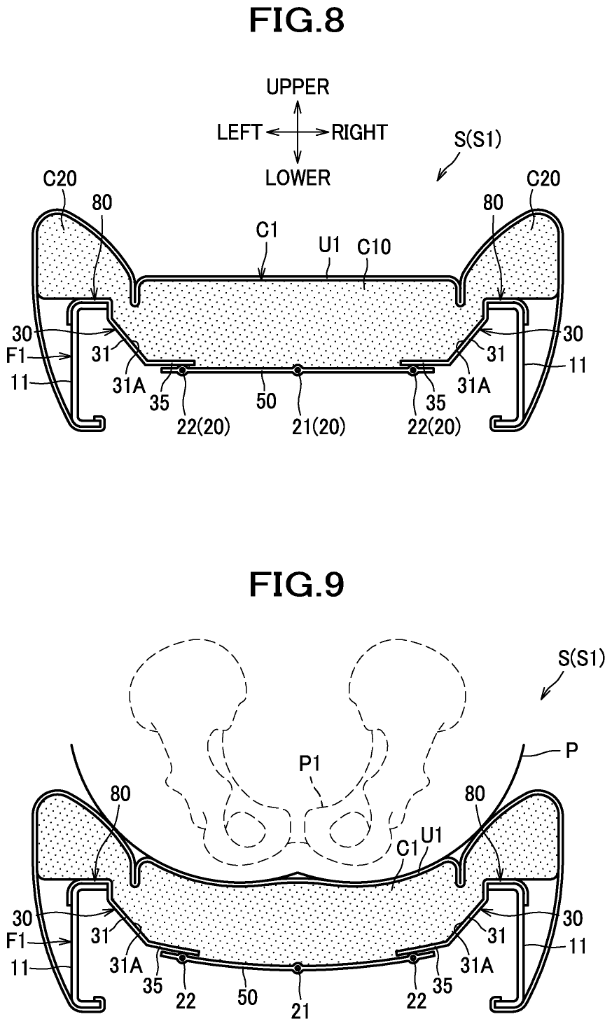

The side supporting members 30 are disposed on the left and right sides of the supporting wires 20. The left and right side supporting members 30 are members configured to support the cushion pad C1 (see FIG. 8) in coordination with the supporting wires 20 and the rear supporting member 70 and other parts, and are made of plastic. Each side supporting member 30 is provided in the corresponding left or right cover member 80. In the present embodiment, the side supporting member 30 is formed as a part of the cover member 80 and integrally molded of plastic, integrally with the cover member 80. To be more specific, the side supporting member 30 is formed to extend from a laterally inner end of the front end portion of the upper cover portion 82 in a laterally inward direction.

The side supporting member 30 includes a side supporting portion 31 as an example of a supporting portion, and an extension portion 35.

The side supporting portion 31 is provided adjacent to the front side of the inner cover portion 81. In other words, in the present embodiment, the cover member 80 with which the side supporting member 30 is integrally formed has a slit 81A between the inner cover portion 81 and the side supporting portion 31; with this slit 81A, a portion of the side frame 11 at a laterally inner side thereof is separated into the inner cover portion 81 and the side supporting portion 31. The slit 81A is cut from a laterally inner edge of the portion of the cover member 80 located at a laterally inner side of the side frame 11, in a laterally outward direction, to be more specific, from a lower edge 81B of the inner cover portion 81 upward.

The side supporting portion 31 is angled to extend obliquely in a laterally-outward-and-upward direction. In other words, the side supporting portion 31 extends from a laterally inner end of the front end portion of the upper cover portion 82 in a laterally-inward-and-downward direction.

Each side supporting portion 31 has a first supporting surface 31A that is an upper surface configured as a supporting surface.

The extension portion 35 is provided to extend from a lower end of the side supporting portion 31 in a laterally inward direction. Each extension portion 35 is located to be laid on the corresponding left or right second supporting wire 22.

Next, a description will be given of operations and advantageous effects of the car seat S configured as described above.

When a seated person P is seated on the car seat S, the side portions of the buttocks and femoral regions of the seated person P can be held and supported from the laterally outer sides by the side supporting portions 31 of the left and right supporting members 30, as shown in FIG. 9. With this configuration, the side portions of the buttocks and femoral regions can be supported more firmly. As a result, the pressure placed around the ischial bones P1 is lowered relatively, so that the seated person P can be supported on the entire region including the ischial bones P1 and their vicinities, the buttocks, and the femoral regions with properly balanced pressure distribution. Accordingly, the blood circulation around the ischial bones P1 of the seated person P is rendered unlikely to become poor, and the fatigue that would be felt by the seated person P can be reduced even on long periods of sitting.

Since the side supporting members 30 are provided in the cover members 80, the both of the cover members 80 and the side supporting members 30 can be attached to the cushion frame F1 by attaching the cover members 80 to the side frames 11. Accordingly, the steps of locating the side supporting members in their installation places independently of the cover members and securing the side supporting members by screws may be obviated, and thus, the number of assembly steps required when members are attached to the cushion frame F1 can be reduced.

Since the side supporting members 30 are formed integrally with the cover members 80, the number of steps required when manufacturing the car seat S can be reduced in comparison with an alternative configuration in which side supporting members and cover members formed as separate parts before members are attached to the cushion frame F1 are mounted.

Since the cover member 80 and the side supporting member 30 are configured as one integral member, and the inner cover portion 81 and the side supporting portion 31 are divided by the slit 81A, the side supporting portion 31 is rendered likely to deflect, in comparison with an alternative configuration in which the inner cover portion and the side supporting portion arranged one at the front side and the other at the rear are connected to each other. Accordingly, when a seated person P is seated on the car seat S, a moderate cushiony property is provided, and an improved ride comfort can be achieved.

Since the side supporting portion 31 has a width of 10 centimeters or more in the front-rear direction, a load can be supported by the side supporting portion 31 having a great width. Accordingly, a person P when seated on the car seat S can be supported with stability, and thus can be provided with an improved ride comfort.

### Third Embodiment

Next, a description will be given of a third embodiment.

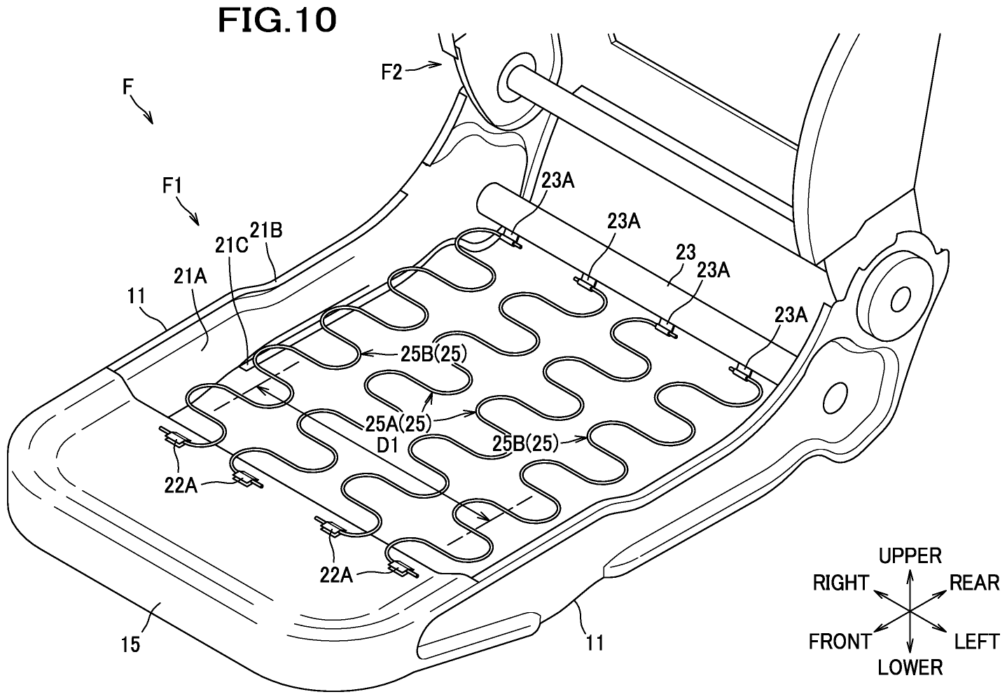

Inside the car seat S of the present embodiment, a seat frame F as shown in FIG. 10 is incorporated. The seat frame F comprises a cushion frame F1 constituting a frame of the seat cushion S1, a back frame F2 constituting a frame of the seat back S2, and a headrest frame (not shown) constituting a frame the headrest S3. The car seat S is constructed of the seat frame F upholstered with a padding made of urethane foam or the like and an outer covering made of fabrics, leather or the like.

The cushion frame F1 includes left and right side frames 11 disposed separately from each other in the lateral direction and extending in the front-rear direction, a front frame 15 connecting front end portions of the left and right side frames 11, and a rear frame 23 connecting rear end portions of the left and right side frames 11.

Each side frame 11 includes a sidewall portion 21A facing in the lateral direction, an upper flange 21B extending from an upper end of the sidewall portion 21A laterally inward, and a lower flange 21C extending from a lower end of the sidewall portion 21A laterally inward. The front frame 15 is a frame made of metal sheet, and is, what is called, a pan frame.

The front frame 15 has four hooks 22A arranged separately in the lateral direction on an upper surface thereof, which hooks 22A are provided by cutting and raising sheet metal which constitutes the front frame 15.

The rear frame 23 is a frame made of pipe. The rear frame 23 has four hooks 23A arranged separately in the lateral direction.

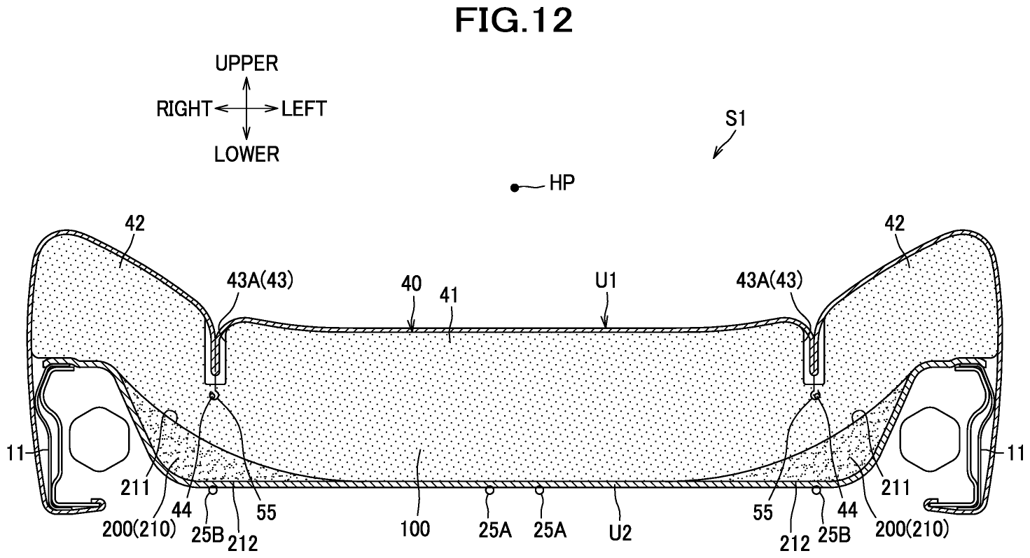

Four S springs 25 as an example of a plurality of supporting members are laid on the cushion frame F1 to connect the front frame 15 and the rear frame 23. Each S spring 25 is an elastically deformable member extending in the front-rear direction while meandering with alternate turns to the left and to the right, and configured to support, from below, a cushion pad 40 which will be described later (see FIG. 12). The four S springs 25 are arranged side by side in the lateral direction, and includes a first S spring 25A as an example of a first supporting member, and a second S spring 25B as an example of a second supporting member.

Two first S springs 25A are disposed at laterally central positions inside the cushion frame F 1. The first S springs 25A are located to extend at or around positions directly under the ischial bones of a seated person.

Two second S springs 25B in all are disposed one on a left side and the other on a right side of the first S springs 25A inside the cushion frame F1. In other words, the left and right second S springs 25B are located separately left and right, and the two first S springs 25A are located between them. The second S springs 25B are located in their entireties at positions laterally outward of lowermost portions of the downwardly protruding ischial bones of the seated person. To be more specific, the laterally central positions of the second S springs 25B are located at positions laterally outward of the lowermost portions of the downwardly protruding ischial bones of the seated person. The distance (pitch) D1 between the laterally central positions of the two second S springs 25B may fall, for example, within a range of 21 to 27 centimeters, preferably within a range of 22 to 26 centimeters.

Front ends of the first S springs 25A and the second S springs 25B are each anchored on a corresponding hook 22A provided on the front frame 15, and rear ends of the first S springs 25A and the second S springs 25B are each anchored on a corresponding hook 23A provided on the rear frame 23. In this way, the first S springs 25A and the second S springs 25B are strung between and thus laid to connect the front frame 15 and the rear frame 23.

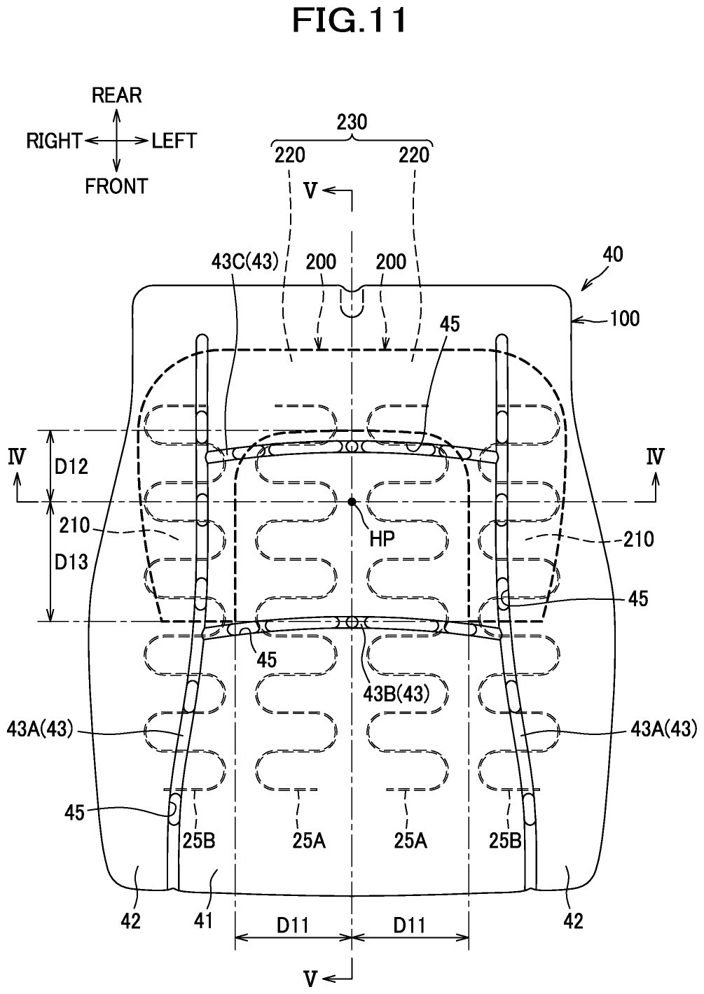

The cushion frame F1 is upholstered with a cushion pad 40 as a padding, and an outer covering U1, as shown in FIG. 11 and FIG. 12.

The cushion pad 40 includes a center portion 41 and left and right side portions 42 so provided at the left and right sides of the center portion 41 as to bulge upward farther than the center portion 41. The cushion pad 40 has a tuck-in groove 43 for the outer covering U1 to be tucked therein.

The tuck-in groove 43 includes left and right first grooves 43A that extend in the front-rear direction, and a second groove 43B and a third groove 43C that extend in the lateral direction.

The left and right first grooves 43A, as one example of a groove, are formed at the left and right sides of the hip point HP to extend along borders between the center portion 41 and respective side portions 42. The second groove 43B is formed at the front side of the hip point HP to connect approximately central portions in the front-rear direction of the left and right first grooves 43A.

The third groove 43C is formed at the rear side of the hip point HP to connect rear portions of the left and right first grooves 43A.

In the cushion pad 40, a tuck-in wire 44 for use in tucking the outer covering U1 in the tuck-in groove 43 is embedded by insert molding. The tuck-in wire 44 is located along the tuck-in groove 43 and partially exposed at a plurality of holes 45 formed at the bottom of the tuck-in groove 43. The outer covering U1 is anchored to the cushion pad 40 with hook members 55 being engaged with exposed portions of the tuck-in wire 44.

In the present embodiment, the cushion pad 40 includes a first pad layer 100 and left and right second pad layers 200 that are harder than the first pad layer 100.

The first pad layer 100 is a portion of the cushion pad 40 which forms an upper layer (outermost layer) of the cushion pad 40.

The second pad layers 200 are portions that form lower layers of the cushion pad 40, and disposed under the first pad layer 100. As shown in FIG. 11, each of the left and right second pad layers 200 includes a main portion 210 extending in the front-rear direction, and an extension portion 220 extending from a rear end portion of the main portion 210 laterally inward. The extension portions 220 of the left and right second pad layers 200 are connected to each other and made integral into one piece, thus forming a connecting portion 230. Accordingly, the left and right second pad layers 200 connected at the laterally extending connecting portions 230 generally have a shape of a letter U. In the present embodiment, both of the main portions 210 and the extension portions 220 (connecting portion 230) of the left and right second pad layers 200 are disposed under the first pad layer 100. In other words, the second pad layers 200 are not exposed at the upper side (outermost or front side) of the cushion pad 40.

The main portions 210 of the left and right second pad layers 200 are located, in positions laterally separate from each other, on left and right sides of the hip point HP of a seated person. The main portion 210 of each second pad layer 200 is located to cover a range in the front-rear direction from a position near the second groove 43B to a position near the rear end portions of the first groove 43A.

The main portion 210 of each second pad layer 200 is located astride the corresponding first groove 43A in the lateral direction. Specifically, the main portion 210 of the left second pad layer 200 is located astride the left first groove 43A, while the main portion 210 of the right second pad layer 200 is located astride the right first groove 43A. To be more specific, each main portion 210 has a predetermined width in the lateral direction, and is located under the corresponding first groove 43A. Each main portion 210 has its laterally outer edge located on a laterally outer side of the corresponding first groove 43A, and its laterally inner edge located on a laterally inner side of the corresponding first groove 43A.

The respective extension portions 220 (connecting portion 230) of the left and right second pad layers 200 are located rearward of the hip point HP. More specifically, the respective extension portions 220 (connecting portion 230) are located rearward of the third groove 43C.

The second pad layer 200 is, when viewed from above or below, not located in a range from the hip point HP to a first distance D11 laterally outward, in a range from the hip point HP to a second distance D12 rearward, or in a range from the hip point HP to a third distance D13 frontward. In other words, the second pad layer 200 is not located within a predetermined area around the hip point HP as viewed from above or below. In the present embodiment, the second pad layer 200 is not located frontward of the second groove 43B.

Moreover, when viewed from above or below, at a coordinate corresponding to the position of the hip point HP with respect to a coordinate axis parallel to the front-rear direction, the second pad layer 200 is located on the second S springs 25B but not on the first S Springs 25A. To be more specific, the main portion 210 of the left second pad layer 200 is located on a rear portion of the left second S spring 25B, and the main portion 210 of the right second pad layer 200 is located on a rear portion of the right second S spring 25B. On the other hand, the main portions 210 of the left and right second pad layers 200 are not located on the first S springs 25A located in laterally central positions. In other words, the main portions 210 are located in positions shifted laterally outward relative to the first S springs 25A. In the present embodiment, the respective extension portions 220 (connecting portion 230) of the left and right second pad layers 200 are located on the rear end portions of the first S springs 25A.

As shown in FIG. 12, the main portion 210 of the second pad layer 200 has an interface 211 with the first pad layer 100, and the interface 211 is, in a cross section intersecting the hip point HP and extending perpendicular to the front-rear direction, located to extend obliquely downward and toward a laterally inner side of the cushion pad 40 and so shaped as to be recessed downward. To be more specific, the interface 211 is formed as a slope or a surface inclined in a laterally-inward-and-downward direction, and further contoured to have a recessed shape of which an angle formed with a horizontal plane gradually decreases toward the laterally inner end.

The main portion 210 of the second pad layer 200 has an undersurface 212 (a surface facing downward) configured as a flat surface generally parallel to the horizontal plane. The main portion 210 of the second pad layer 200 having its interface 211 configured as a slope inclined downward with respect to a direction toward the laterally inner side, and its undersurface 212 configured as a flat surface generally parallel to the horizontal plane assumes a generally triangular shape of which, in particular, a portion laterally inward of the left and right first grooves 43A (see alternate long and short dashed lines) has a thickness (vertical thickness) decreasing toward a laterally inner side.

On the other hand, of the first pad layer 100, a portion laterally inward of the left and right first grooves 43A, more specifically, portions located on the laterally inward portions of the main portions 210 (laterally inward of the left and right first grooves 43A), is configured to have a thickness decreasing toward laterally outer sides. Accordingly, the center portion 41, which is a portion laterally inward of the first grooves 43A, of the cushion pad 40 has a relatively thin shape of which a thickness is substantially uniform in the lateral direction.

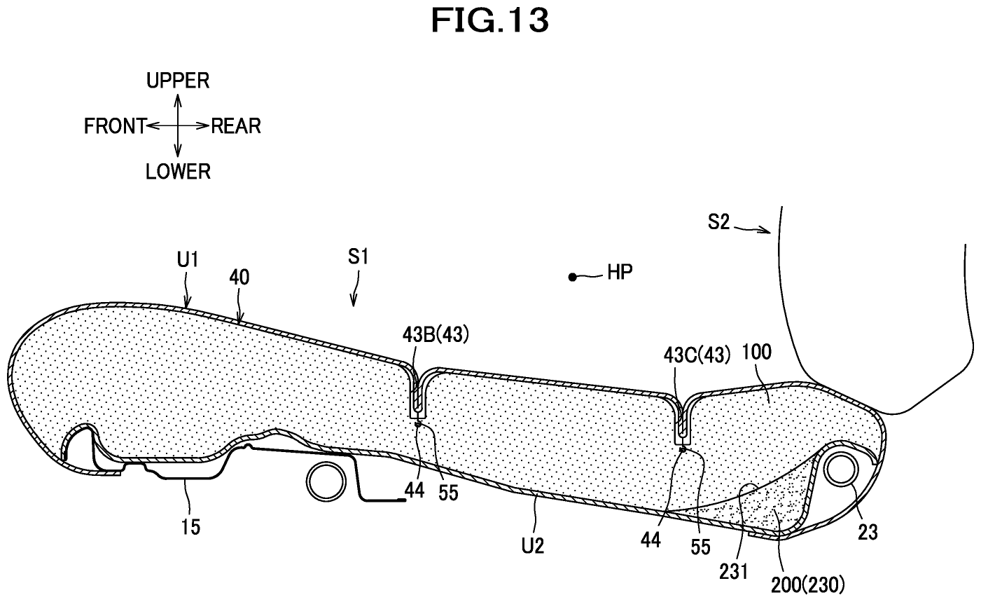

As shown in FIG. 13, the connecting portion 230 of the second pad layer 200 has an inter face 231 with the first pad layer 100, and the interface 231 is, in a cross section intersecting the hip point HP and extending perpendicular to the lateral direction, located to extend obliquely in a downward-and-frontward direction as well as so shaped as to be recessed downward. To be more specific, the interface 231 is formed as a slope or a surface inclined in a frontward-and-downward direction, and further contoured to have a recessed shape of which an angle formed with the horizontal plane gradually decreases toward the front end.

A sheet member U2 is disposed at an undersurface (back surface) of the cushion pad 40. The sheet member U2 is a sheet-shaped member provided to improve the rigidity of the cushion pad 40 as well as to restrain the back surface of the cushion pad 40 from getting torn or abate noises from the road. The seat member U2 may be provided using, for example, unwoven fabrics, coarse cloth, or the like.

Next, a description will be given of operations and advantageous effects of the car seat S configured as described above.

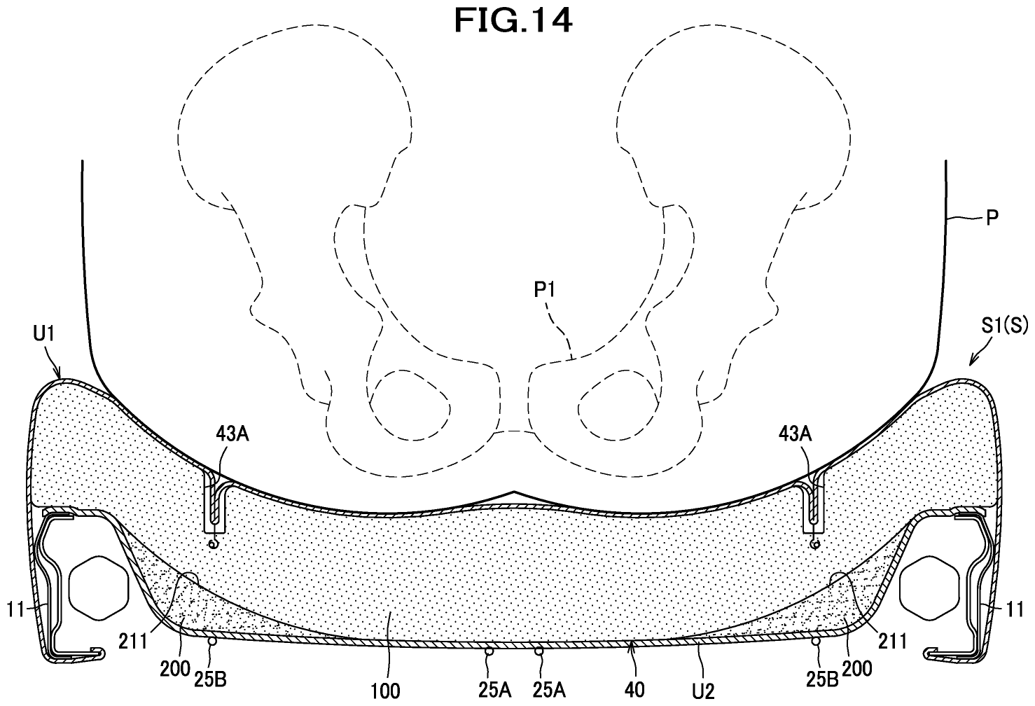

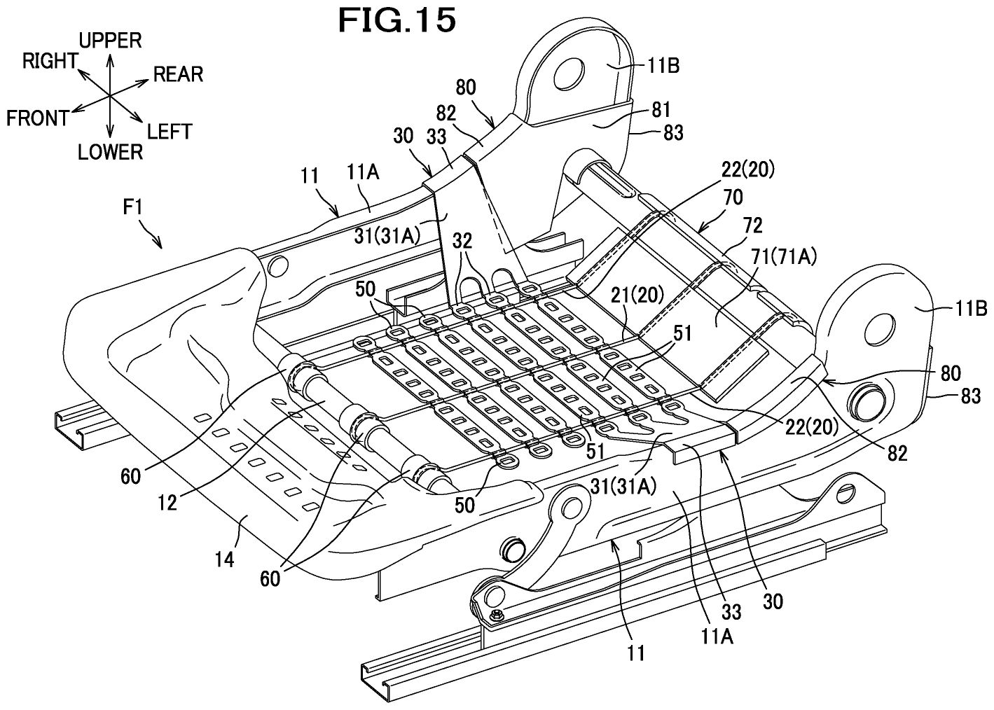

Since the seat cushion S1 of the car seat S is, as shown in FIG. 14, is configured such that the interfaces 211 between the main portions 210 of the second pad layers 200 located at the left and right sides under the first pad layer 100 and the first pad layer 100 are formed as a slope or a surface inclined in the laterally-inward-and-downward direction and contoured to have a recessed shape, the interface 211 can be contoured to fit the shape of a human body.

Moreover, since the side portions of the buttocks and femoral regions of the seated person P, when seated on the car seat S, can be held from their laterally outer sides and supported by the second pad layers 200, the side portions of the buttocks and femoral regions of the seated person P can be supported more firmly in comparison with an alternative configuration in which no second pad layer 200 is disposed therein. As a result, the pressure placed on the ischial bones P1 and their vicinities are lowered relatively, and thus the seated person can be supported on the entire region including the ischial bones P1 and their vicinities, the buttocks, and the femoral regions with properly balanced pressure distribution. Accordingly, the blood circulation around the ischial bones P1 of the seated person P is rendered unlikely to become poor, and the fatigue which the seated occupant would feel can be reduced even on long periods of sitting.

Since each of the second pad layers 200 is located astride the corresponding first groove 43A in the lateral direction, the second pad layer 200 (main portion 210) of a sufficient width can be provided with more certainty in comparison with an alternative configuration in which the second pad layers 200 are located only on the laterally inner sides of the first grooves 43A. As a result, the interface 211 between the main portion 210 and the first pad layer 100 can be contoured to fit a human body, in particular, the shape of the side portions of the buttocks and femoral regions thereof, over a wide range in the lateral direction; therefore, the side portions of the buttocks and femoral regions of a seated person P when seated on the car seat S can be supported firmly by the second pad layers 200, so that the fatigue that would be felt can be reduced even on long periods of sitting.

If the second pad layers are located only the laterally outer sides of the first grooves 43A, the second pad layers would be located in positions separate, farther from the seated person P, and thus, would not be able to sufficiently achieve the function of the second pad layers to lessen the fatigue that would be felt; contrariwise, if the second pad layers 200 are located astride the first grooves 43A, the function of the second pad layers 200 can be achieved at a sufficient level, so that the fatigue that would be felt can be reduced even on long periods of sitting.

Since the portions of the second pad layers 200 located laterally inward of the first grooves 43A each have a thickness decreasing in a laterally inward direction, the cushion pad 40 having the function of reduced fatigue even on long periods of sitting can be made thinner in comparison with an alternative configuration in which the second pad layers have a uniform thickness.

Since the portion of the first pad layer 100 located laterally inward of the first grooves 43A has a thickness decreasing in a laterally outward direction, the cushion pad 40 having the function of reduced fatigue even on long periods of sitting can be made thinner in comparison with an alternative configuration in which the first pad layers have a uniform thickness.

Since the second pad layers 200 include extension portions 220, the rear portions of the buttocks of a seated person P can be supported on the softer first pad layer 100 by the hard second pad layers 200, the seated person P can be supported stably while ensuring his/her improved ride comfort.

Particularly, since the left and right second pad layers 200 in the present embodiment are connected by the connecting portion 230, the entire rear portions of the buttocks of a seated person P can be supported stably while ensuring his/her improved ride comfort.

Since the interface 231 between the connecting portion 230 and the first pad layer 100 is a slope or a surface inclined in a downward-and-frontward direction and contoured to have a recessed shape, the interface 231 may provide a shape conforming to the shape of the buttocks and lumbers of a human body. Accordingly, the seated person P when seated on the car seat S may not feel any sharp change in hardness thereon, and thus can be provided with an improved ride comfort.

Although the hard second pad layers if located near the hip point HP would possibly lower the degree of alleviation of a feel of fatigue because the pressure is likely to be placed on the ischial bones and their vicinities, the present embodiment is configured such that the second pad layer 200 is not disposed within a predetermined range near the hip point HP, so that the pressure placed on regions near the ischial bones P1 can be lowered with higher probability in comparison with an alternative configuration in which the second pad layers are disposed near the hip point HP. With this configuration, the blood circulation around the ischial bones P1 of the seated person P is rendered unlikely to become poor, and the fatigue that would be felt can be reduced even on long periods of sitting.

Since the main portions 210 of the second pad layers 200 are located on the second S springs 25B, the second pad layers 200 (main portions 210) located at left and right sides of the hip point HP can be supported from below by the left and right second S springs 25B. As a result, the second pad layers 200 can be restrained from sagging down when a seated person P is seated on the car seat S. Accordingly, the function of the second pad layers 200 can be achieved sufficiently, so that the fatigue that would be felt can be reduced even on long periods of sitting.

Moreover, since the first S springs 25A are disposed under the laterally central positions of the cushion pad 40, the first pad layer 100 on and around the hip point HP can be supported from below by the first S springs 25A. Accordingly, the soft first pad layer 100 can be restrained from sinking down excessively when a seated person P is seated on the car seat S, so that an improved ride comfort can be achieved.

Although some embodiments of the present invention are described above, the present invention is not limited to the above-described embodiments. Specific configurations may be changed where appropriate without departing from the gist of the invention, as will be described below.

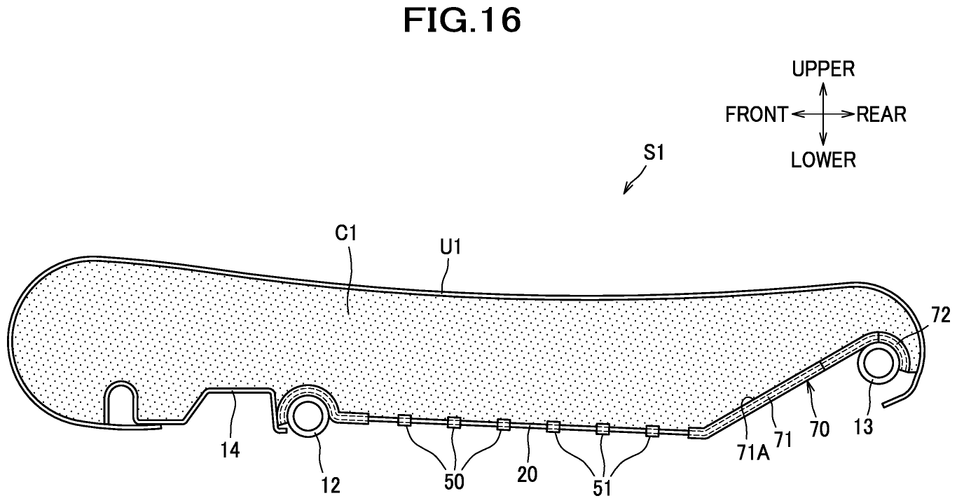

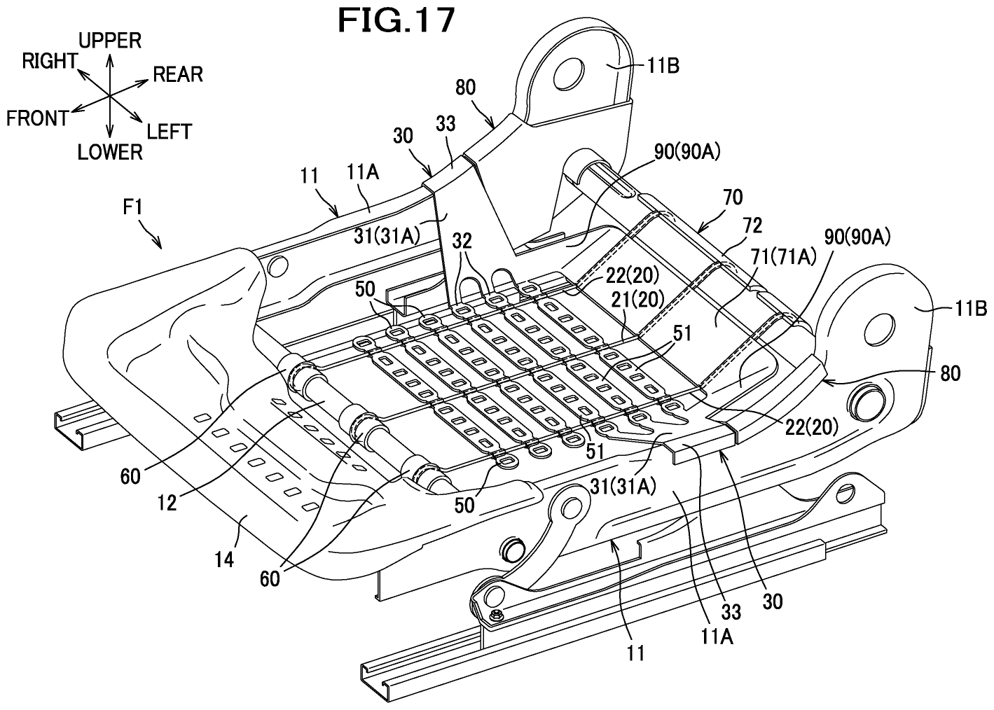

For example, as shown in FIG. 15 and FIG. 16, where the rear portion of the supporting wire 20 is angled to extend obliquely in a rearward-and-upward direction, and curved approximately in the form of a segment of a circle along an outer peripheral surface of the rear frame 13, the plate-shaped rear supporting portion 71 of the rear supporting member 70 may be located obliquely to extend in a rearward-and-upward direction. To elaborate, the embodiment shown in FIG. 15 and FIG. 16 is such that the rear supporting portion 71 of the rear supporting member 70 has a second supporting surface 71A that is an upper surface thereof. The second supporting surface 71A assumes a slope or surface inclined in the rearward-and-upward direction because the plate-shaped rear supporting portion 71 is located obliquely in the rearward-and-upward direction. With this configuration, a portion contoured to fit the shape of a human body as viewed from a left or right side may be formed by the supporting wires 20 and the second supporting surface 71A, so that a seated person P when seated on the seat cushion 51 can be provided with an improved ride comfort.

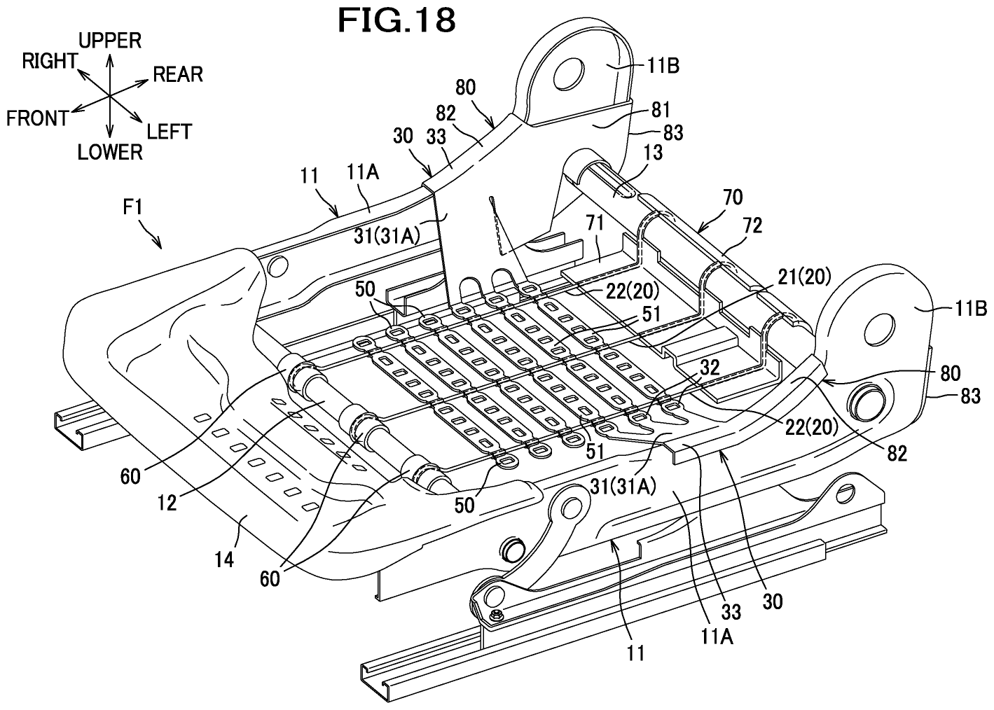

As shown in FIG. 17, the left and right side supporting members 30 may be formed continuously and integrally with the rear supporting member 70. To be more specific, the side supporting portions 31 of the left and right side supporting members 30 are connected to the rear supporting portion 71 by plate-shaped side connecting portions 90. The side connecting portions 90 each have a third supporting surface 90A that is an upper surface, and the third supporting surface 90A assumes a slope or a surface inclined in a laterally-outward-and-upward direction with respect to the cushion frame F1 to smoothly connect the first supporting surface 31A and the second supporting surface 71A. With this configuration, the left and right side supporting members 30, the rear supporting member 70, and the supporting wires 20 may be configured as an easy-to-manipulate integral part, so that these can be attached to the cushion frame F1 easily.

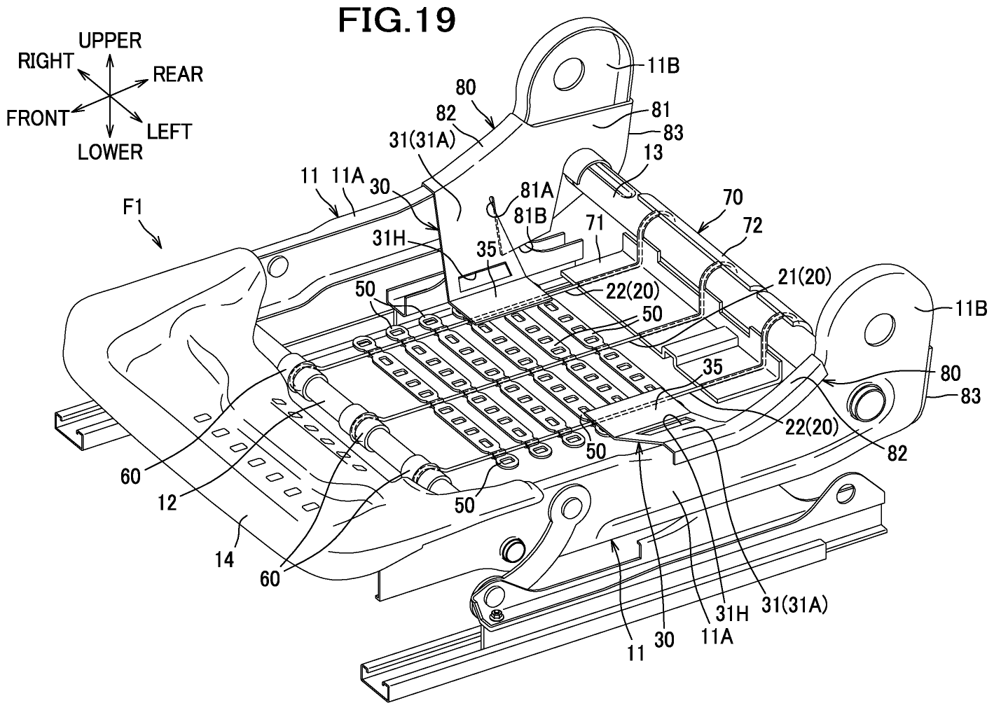

As shown in FIG. 18, the side supporting member 30 may be formed continuously and integrally with the cover member 80. To be more specific, the side supporting members 30 is configured such that the rear end of its engagement portion 33 is formed continuously and integrally with the front end of the upper cover portion 82 of the cover member 80. With this configuration, the cover members 80, the side supporting members 30 and the supporting wires 20 can be manipulated as an integral part, so that the number of assembly steps for the car seat S can be further reduced.

As shown in FIG. 19, the side supporting portion 31 may have a through hole 31H. In the embodiment shown in FIG. 19, the through hole 31H is, for example, configured to assume a generally trapezoidal shape elongated in the front-rear direction, and is formed at a lower section of the side supporting portion 31. Provision of the through hole 31H in the side supporting portion 31 may make the side supporting member 30 lightweight, so that weight reduction of the car seat S including the side supporting members 30 can be achieved. Moreover, since any other members such as a wire harness, a duct for air conditioning, etc. may be disposed through the through hole 31H, the limited space inside the car seat S can be utilized effectively. It is to be understood the shape, number, position of the through hole to be provided may be determined as appropriate without limitation.

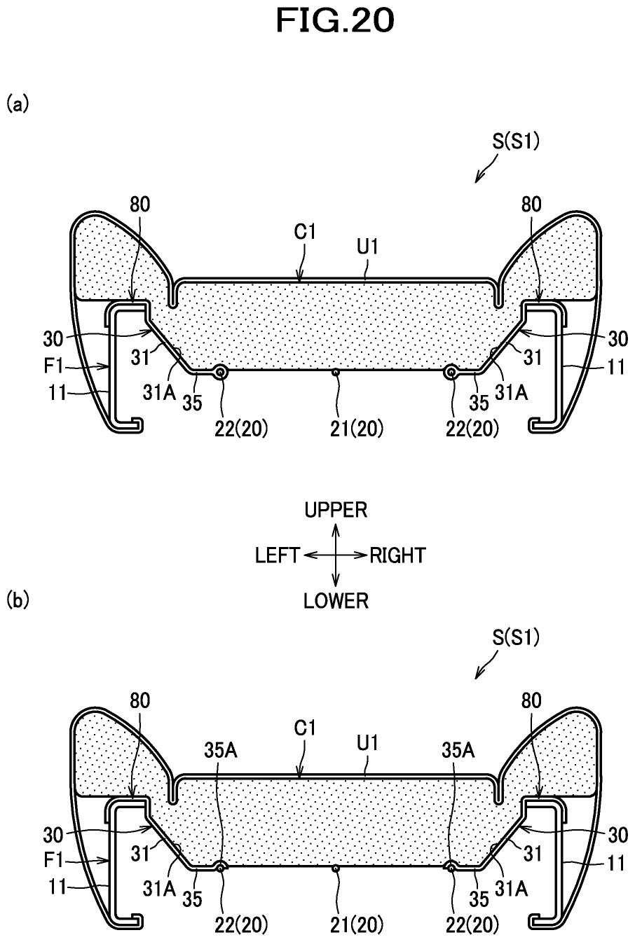

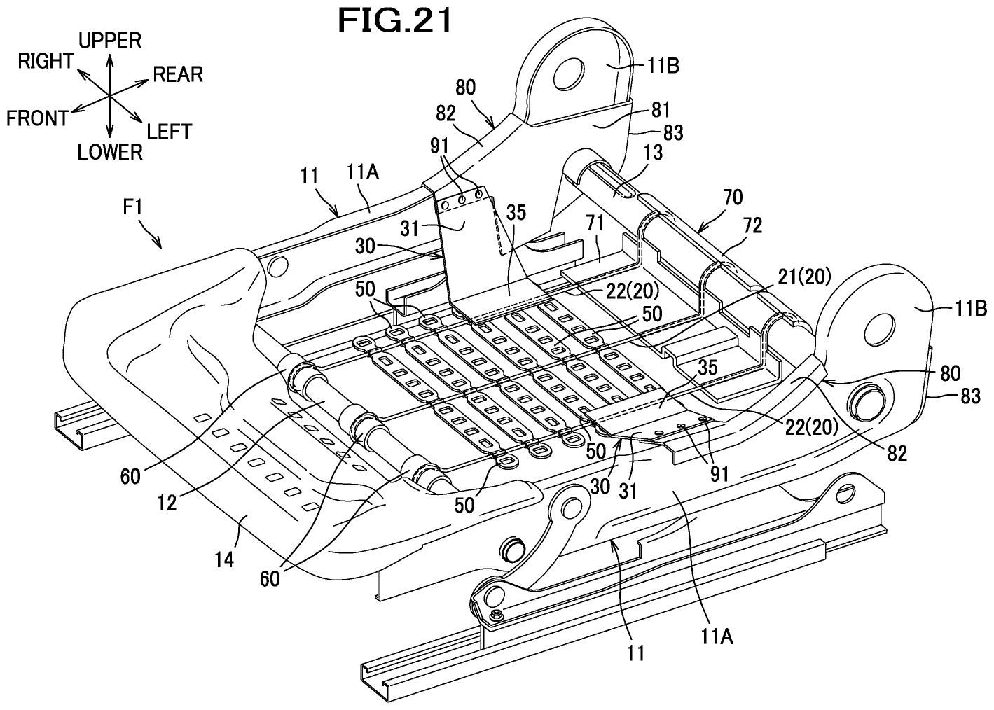

As shown in FIG. 20(a),(b), the side supporting members 30 may have their laterally inner ends connected to the second supporting wires 22. For example, in the embodiment shown in FIG. 20(a), the side supporting members 30 are provided such that with laterally inner end portions of the extension portions 35, parts of the second supporting wires 22 are covered around their entire circumferences as if the parts of the second supporting wires 22 are enveloped; thus, the side supporting members 30 are connected to the second supporting wires 22. In other words, the second supporting wires 22 are disposed through the laterally inner end portions of the extension portions 35. Such a structure having the metal second supporting wire 22 and the plastic side supporting member 30 formed integrally in one piece may be formed, for example, by insert molding of the second supporting wire 22 and the side supporting member 30.

In the embodiment shown in FIG. 20(b), the side supporting members 30 have hook-shaped engagement portions 35A at laterally inner end portions of the extension portions 35, each of these engagement portions 35A being engaged with a portion of the second supporting wire 22, and thereby are connected to the second supporting wires 22.

Since the side supporting members 30 are connected to the second supporting wires 22 as described above, the second supporting wires 22 can be restrained by the side supporting members 30 from sinking down excessively. Accordingly, a person when seated on the car seat S can be provided with an improved ride comfort. It is to be understood that the left and right side supporting members 30 may be formed, for example, integrally with the wire connecting members 50 (see FIG. 7) and thereby connected to each of the second supporting wires 22 and to the first supporting wire 21. To elaborate, the left and right side supporting members 30 may be connected by the wire connecting members 50 and thereby formed integrally in one piece.

Although the side supporting member 30 in the second embodiment is formed integrally with the cover member 80, compatible configurations are not limited thereto. For example, as shown in FIG. 21, the side supporting member 30 may be formed as an independent part separate from the cover member 80. In the embodiment shown in FIG. 21, the side supporting member 30 is provided on the cover member 80, for example, with the upper end portion of the side supporting portion 31 being fixed to the cover member 80 by a mounting member 91 such as screws, rivets or the like.

In the first and the second embodiments, the cover member 80 includes the inner cover portion 81, the upper cover portion 82, and the rear cover portion 83, but these are not essential. For example, the cover member may include the inner cover portion 81 and the rear cover portion 83 but not include the upper cover portion 82; alternatively, the cover member may include the inner cover portion 81 and the upper cover portion 82 but not include the rear cover portion 83. Also, the cover member may include the inner cover portion 81 but not include either of the upper cover portion 82 or the rear cover portion 83. In other words, a member configured to cover at least part of a laterally inner side of a rear end portion of the side frame may suffice for the cover member.

Although the car seat S in the first and second embodiments is described as comprising the rear supporting member 70 by which the supporting wires 20 are connected, this is not essential. For example, the car seat may not comprise any rear supporting member. In this alternative as well, the rear end portions of the supporting wires which are hooked on the rear frame may preferably be covered with plastic members. With this configuration, noises as would be produced by metal-to-metal contact can be prevented.

Although the left and right side supporting members 30 in the first embodiment are connected by and integrally formed together with the connecting part 51, feasible configurations are not limited thereto, and include, for example, an alternative configuration in which the left and right side supporting members may not be connected.

Although a configuration in which the engagement portions 33 are hooked on the side frames 11 from above is illustrated in the first embodiment, feasible configurations are not limited thereto. For example, the engagement portion may be configured to be engageable in a hole formed in the side frame. Alternatively, the engagement portion may be configured otherwise, e.g., may configured to engage with a hook-shaped portion formed on the side frame.

Although the side supporting portion 31 in the first and second embodiments has a generally trapezoidal shape of which a width in the front-rear direction increases toward a laterally inner end, feasible configurations are not limited thereto. For example, the side supporting portion may have a portion (i.e., not along the whole length) shaped to have a width in the front-rear direction increasing toward a laterally inner end. Alternatively, the side supporting portion may have a shape (e.g., generally rectangular shape) of which a width in the front-rear direction is almost unvarying.

Although the side supporting portion 31 having the first supporting surface 31A in the first and second embodiments is in the shape of a plate, there may be other compatible shapes not limited thereto. For example, the side supporting portion may have thicknesses varying in such a manner as to assume a generally triangular shape in cross section taken for viewing with line of sight aligned parallel to the front-rear direction.

Although the first supporting surface 31A in the first and second embodiments is a surface inclined in a laterally-outward-and-upward direction, feasible configurations are not limited thereto; for example, the first supporting surface may be a surface facing upward. The first supporting surface may be a flat surface or a curved surface.

Although the side supporting member 30 and the rear supporting member 70 in the first embodiment are so provided as to cover and envelop parts of the supporting wires 20 around their entire circumferences, and are formed integrally with the supporting wires 20, there may be other feasible configurations not limited thereto. For example, the side supporting member and/or the rear supporting member may be formed integrally with the supporting wires by engaging their portions having a U-shaped or C-shaped cross section with parts of the supporting wires. In other words, the side supporting member and/or the rear supporting member may be configured not to cover the supporting wires 20 around their entire circumferences (i.e., not to envelop them).

Although only one first supporting wire 21 is disposed at a laterally central position in the first and second embodiments, feasible configurations are not limited thereto; for example, a plurality of first supporting wires may be arranged side by side in the lateral direction. Although illustrated as a linear member in the first and second embodiments is the second supporting wire 22 (supporting wire 20), there may be other compatibly configured members not limited thereto; for example, such a linear member may be selected among various members which includes an elastically deformable member, such as an S spring, at least part of which is bent to meander with alternate turns to the left and to the right.

Although illustrated as a pad supporting member in the second embodiment is the supporting wire 20 that is a wire-shaped member, there may be other compatibly configured members not limited thereto; for example, the pad supporting member may be a plate-shaped member. Another alternative configuration may be such that a wire-shaped pad supporting member is disposed in the position of the second supporting wire 22 as in the second embodiment, and a plate-shaped pad supporting member is disposed in the position of the first supporting wire 21 as in the second embodiment. In other words, if a plurality of pad supporting members are disposed, they may have different configurations.

Although illustrated as front and rear cross members in the first and second embodiments are the front frame 12 and the rear frame 13, there are other compatibly configured members not limited thereto. For example, the pan frame 14 as shown in FIG. 2 or the like may be used instead as the front cross member. Similarly, the rear cross member may not be a member formed of a pipe material, but be a member formed of a metal sheet. Although the side frames formed of a metal sheet is illustrated in the first and second embodiments, there may be other usable material not limited thereto; for example, they may be formed of a pipe material.

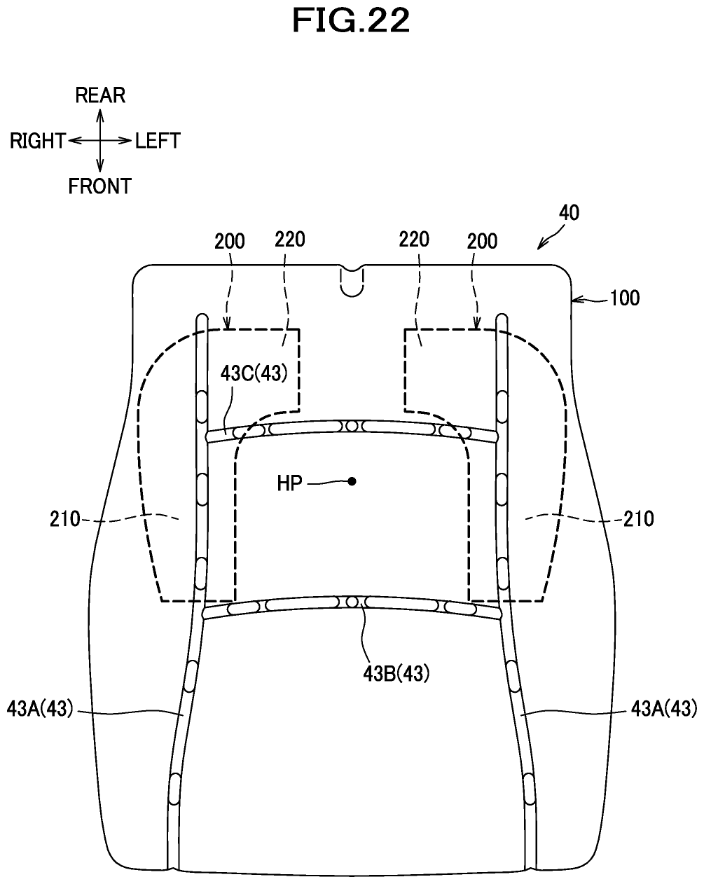

Although the left and right second pad layers 200 are connected by the connecting portion 230 in the third embodiment, this configuration is not essential. For example, as shown in FIG. 22, the left and right second pad layers 200 may include extension portions 220 not connected to each other.

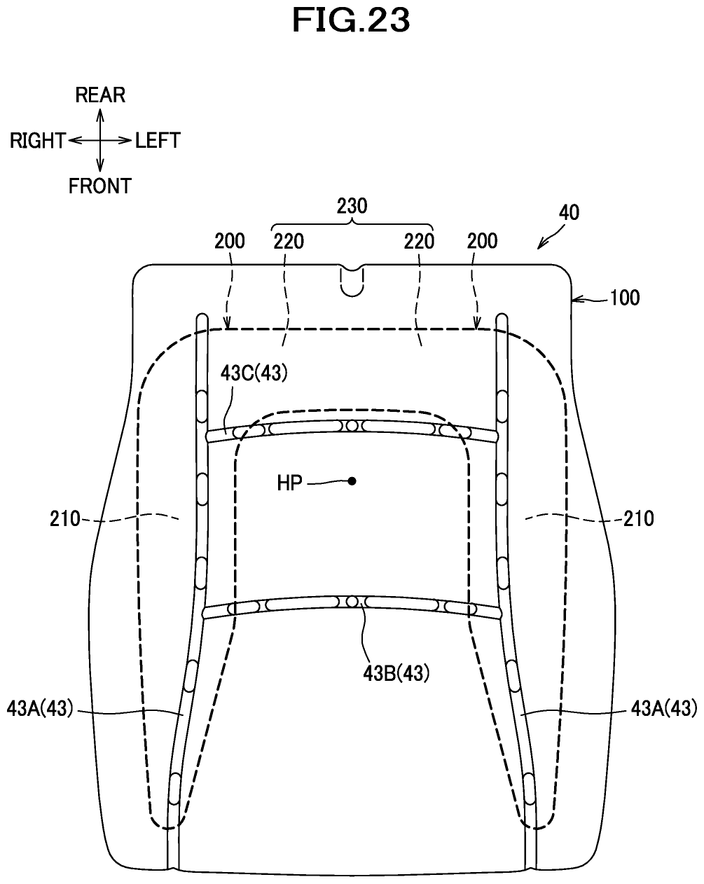

Although the configuration illustrated in the third embodiment is such that the second pad layers 200 are not disposed in any position frontward of the second groove 43B, feasible configurations may not be limited thereto. For example, as shown in FIG. 23, the left and right second pad layers 200 may be disposed across the second groove 43B frontward. To be more specific, the embodiment illustrated in FIG. 23 is such that the main portion 210 of each second pad layer 200 is so located along the first groove 43A as to span a range from the front end portion to the rear end portion of the cushion pad 40 in the front-rear direction.

In the embodiment illustrated in FIG. 23, at least parts of the left and right second pad layers 200 located in positions frontward of the hip point HP, specifically, portions of the main portions 210 located frontward of the second groove 43B, have a width in the lateral direction decreasing gradually toward its front end. To be more specific, laterally outer edges of portions of the main portions 210 located frontward of the second groove 43B extend generally straight along the front-rear direction, while laterally inner edges of the portions thereof located frontward of the second groove 43B are so located as to extend in frontward-and-laterally-outward directions. With this configuration, in which the hard second pad layers 200 are so located as to extend in an obliquely frontward direction deviating gradually from the femoral regions of a seated person, a seated person when seated on the car seat S fails to feel any sharp change in hardness thereon, and thus can be provided with an improved ride comfort.

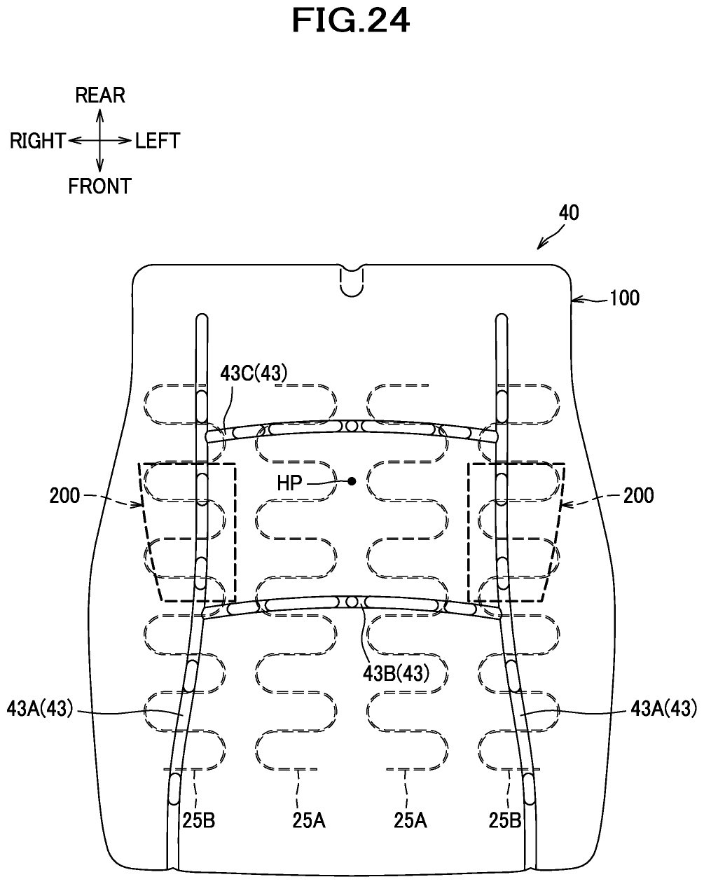

Although the second pad layers 200 in the third embodiment include the main portions 210 extending in the front-rear direction at the left and right sides of the hip point HP, and the extension portions 220 located in positions rearward of the hip point HP and extending laterally inward, feasible configurations are not limited thereto. For example, as shown in FIG. 24, the second pad layers 200 may be configured to include no extension portion. It is to be understood that the second pad layers 200 located at least in positions at the left and right sides of the hip point HP may suffice for desired advantageous effects of firm support of the side portions of the buttocks and the femoral regions of a seated person by the second pad layers 200 and a relatively lowered pressure around the ischial bones P1.

In the embodiment shown in FIG. 24, the second pad layers 200 are, along the length in the front-rear direction, located on the second S springs 25B, but not located on the first S springs 25A. In other words, the left and right second pad layers 200 in the embodiment shown in FIG. 24 fails to include any portion located on the first S springs 25A.

The interface 211 between the second pad layer 200 and the first pad layer 100 in the third embodiment is a slope or a surface inclined in a laterally-inward-and-downward direction and assumes a recessed shape; it is desirable that this shape vary gradually to conform to the shape of the human body. In other words, the interfaces of the left and right second pad layer formed with the first pad layer may preferably be contoured to conform to the shape of the human body to an extent practicable.

Although two first S springs 25A, as a first supporting member, are disposed at laterally central positions in the third embodiment, feasible arrangements are not limited thereto; for example, the number of the first S springs may be only one, or three or more. Although the second S springs 25B, as a second supporting member, are disposed one at each of the left and right sides of the first S spring 25A, feasible arrangements are not limited thereto; for example, a plurality of the second S springs may be disposed at each of the left and right sides. In the third embodiment, the supporting member is exemplified by the S springs 25, but there may be other feasible members not limited thereto; for example, wire-shaped members other than S springs may be adopted, or a plate-shaped member may also be adoptable. Although both of the first supporting member and the second supporting member in the third embodiment are supporting members having the same configurations (i.e., S springs 25), there may be other feasible combinations not limited thereto; for example, supporting members having different configurations may be adopted, e.g., one is a wire-shaped member, while the other is a plate-shaped member.

Although the S springs 25 as a supporting member in the third embodiment are engaged on the hooks 22A, 23A provided on the front frame 15 and the rear frame 23, and thereby attached to the cushion frame F1, any other methods of attaching the supporting member may be adopted without limitation. For example, the supporting member may be fastened with screws, welded or otherwise attached thereto, or may be attached using other mounting members other than the hook 22A, 23A.

Although the second pad layers 200 are so located under the first pad layer 100 as to be exposed at underside of the cushion pad 40, there may be other feasible arrangements not limited thereto. For example, the second pad layers may be embedded in the first pad layer without being exposed at the underside of the cushion pad.

Although the cushion pad 40 in the third embodiment is configured to comprise two kinds of layers consisting of the first pad layer 100 and the second pad layers 200, feasible configurations are not limited thereto; for example, one or more other kind of layers may be provided in addition to the first pad layer and the second pad layers. In such alternatives, the layers other than the first and the second pad layers may be arranged between the first pad layer and the second pad layers in the vertical direction.

Although the first pad layer 100 and the second pad layers 200 in the third embodiment are each configured to comprise a single padding (part), feasible configurations are not limited thereto, and each may be configured to comprise a plurality of parts. In other words, at least one of the first pad layer 100 and the second pad layer 200 may be configured to comprise a plurality of parts assembled together. Alternatively, at least one of the first pad layer 100 and the second pad layer 200 may comprise a plurality of layers. In such alternative, the respective layers may be equal or different in terms of hardness.

In the above-described embodiments, the car seat S installed in an automobile is illustrated as a seat; however, the seat may be a vehicle seat installed in a vehicle other than an automobile, for example, in a railcar, ship, aircraft, etc. Furthermore, the seat may not be limited to the vehicle seat, but, may be a seat for use in households or the like, for example.

Any of the elements explained in relation to the above-described embodiments and modified examples may be implemented in combination as desired.

1. A seat comprising:
a cushion frame including left and right side frames disposed separately from each other in a lateral direction, and front and rear cross members by which the left and right side frames are connected;
left and right linear members located separately from each other in the lateral direction and laid to connect the front and rear cross members; and
left and right side supporting members made of plastic and formed integrally with the linear members,
wherein the side supporting members each include an engagement portion engageable with a corresponding side frame.

2. The seat according to claim 1, wherein each side supporting member has a first supporting surface located at a laterally inner side of the side frame, and
wherein the first supporting surface is so located as to extend obliquely in a laterally-outward-and-upward direction.

3. The seat according to claim 1, wherein the side supporting members each include a plate-shaped supporting portion disposed at a laterally inner side of the side frame, and
wherein at least part of the supporting portion has a width in a front-rear direction increasing toward a laterally inner end.

4. The seat according to claim 1, wherein the engagement portion is configured to hook on the side frame from above, to thereby engage with the side frame.

5. The seat according to claim 1, wherein the left and right side supporting members are connected by and integrally formed with a connecting part extending in the lateral direction.

6. The seat according to claim 1, further comprising a rear supporting member made of plastic, the rear supporting member being formed integrally with rear end portions of the left and right linear members and connecting the left and right linear members.

7. The seat according to claim 6, wherein the rear supporting member has a second supporting surface located frontward of the rear cross member, and
wherein the second supporting surface is so located as to extend obliquely in a rearward-and-upward direction.

8. The seat according to claim 6 or claim 7, wherein the left and right side supporting members are connected to and formed integrally with the rear supporting member.

9. The seat according to claim 1, further comprising left and right cover members made of plastic, with which at least laterally inner sides of rear end portions of the side frames are covered,
wherein the side supporting members are connected to and formed integrally with the cover member.

10. The seat according to claim 1, further comprising:
a pad supporting member disposed between the left and right side frames to support a cushion pad; and
left and right cover members made of plastic, with which at least laterally inner sides of rear end portions of the side frames are covered,
wherein the left and right side supporting members are members located respectively on the left and right sides of the pad supporting member and configured to support the cushion pad in coordination with the pad supporting member, and wherein the side supporting members are provided in the cover members.

11. The seat according to claim 10, wherein the left and right side supporting members are located, respectively, on left and right sides of a hip point of a seated person, and wherein each of the side supporting members is located within a range including the hip point in a front-rear direction.

12. The seat according to claim 10, wherein the side supporting members are formed integrally with the cover members.

13. The seat according to claim 12, wherein the cover members each include an inner cover portion with which laterally inner sides of the rear end portion of the corresponding side frame is covered,
wherein the side supporting members each include a supporting portion disposed at a laterally inner side of the corresponding side frame and provided adjacent to the inner cover portion, and
wherein a slit cut from an edge on a laterally inner side toward a laterally outer side in the lateral direction is provided between the inner cover portion and the supporting portion.

14. The seat according to claim 13, wherein the supporting portion has a width of 10 centimeters or more in a front-rear direction.

15. The seat according to claim 10, wherein the pad supporting member incorporates the left and right linear members, and
wherein the side supporting members have laterally inner ends connected to the linear members.

16. The seat according to claim 10, wherein the side supporting members each include a supporting portion disposed at a laterally inner side of the side frame, and
wherein the supporting portion has a through hole.
